(19) United States
(12) Patent Application Publication
(10) Pub. No.: US 2020/0367171 A1
(43) Pub. Date: Nov. 19, 2020

(54) DISCRETIONARY ON DURATION FOR WIRELESS DEVICES

(71) Applicant: QUALCOMM Incorporated, San Diego, CA (US)

(72) Inventors: Shiau-He Tsai, San Diego, CA (US); Zae Yong Choi, San Jose, CA (US); Raghu Narayan Challa, San Diego, CA (US); Alexei Yurievitch Gorokhov, San Diego, CA (US); Jafar Mohseni, San Diego, CA (US)

(21) Appl. No.: 16/857,414

(22) Filed: Apr. 24, 2020

Related U.S. Application Data
(60) Provisional application No. 62/849,801, filed on May 17, 2019.

(51) Int. Cl. H04W 52/02

(52) U.S. Cl. CPC H04W 52/0248; H04W 52/0216

(57) ABSTRACT

Methods, systems, and devices for wireless communications are described to enable a user equipment (UE) to employ a discretionary on mode (e.g., powering receiver circuitry) in order to conserve power during discontinuous reception. The UE may discretionarily cut down an on time duration by delaying wake-up (e.g., powering on receiver circuitry) or by sleeping (e.g., powering down receiver circuitry) during portions of an on duration. The UE may also discretionarily skip one or more on durations. The UE may use hybrid automatic repeat request retransmissions to receive information that may be missed when sleeping during a configured on duration. The UE may evaluate one or more conditions in order to determine whether to employ a discretionary on mode. For example, the UE may determine to conserve power based on one or more of a data traffic type, a battery level, a channel condition, a retransmission policy, or physical layer activities.

### CROSS REFERENCE

The present Application for Patent claims the benefit of U.S. Provisional Patent Application No. 62/849,801 by TSAI et al., entitled “DISCRETIONARY ON DURATION FOR WIRELESS DEVICES,” filed May 17, 2019, assigned to the assignee hereof, and expressly incorporated by reference herein.

### INTRODUCTION

The following relates generally to wireless communications and more specifically to managing discontinuous reception (DRX).

Wireless communications systems are widely deployed to provide various types of communication content such as voice, video, packet data, messaging, broadcast, and so on. These systems may be capable of supporting communication with multiple users by sharing the available system resources (e.g., time, frequency, and power). Examples of such multiple-access systems include fourth generation (4G) systems such as Long Term Evolution (LTE) systems, LTE-Advanced (LTE-A) systems, or LTE-A Pro systems, and fifth generation (5G) systems which may be referred to as New Radio (NR) systems. These systems may employ technologies such as code division multiple access (CDMA), time division multiple access (TDMA), frequency division multiple access (FDMA), orthogonal frequency division multiple access (OFDMA), or discrete Fourier transform spread orthogonal frequency division multiplexing (DFT-S-OFDM). A wireless multiple-access communications system may include a number of base stations or network access nodes, each simultaneously supporting communication for multiple communication devices, which may be otherwise known as user equipment (UE).

### SUMMARY

A method of wireless communications at a UE is described. The method may include receiving signaling to identify, by the UE, scheduling information for a downlink data transmission from a base station to the UE and determining a set of transmission opportunities associated with the downlink data transmission within an on duration based on the scheduling information and one or more retransmission parameters configured for the UE. The method may further include skipping monitoring of one or more first transmission opportunities of the set of transmission opportunities by maintaining a sleep state during the on duration based on the scheduling information and the one or more retransmission parameters configured for the UE. The method may also include monitoring, by the UE in an awake state during the on duration, for a retransmission of the downlink data transmission during one or more second transmission opportunities after the one or more first transmission opportunities of the set of transmission opportunities.

An apparatus for wireless communications at a UE is described. The apparatus may include a processor and memory coupled with the processor. The processor and memory configured to receive signaling to identify, by the UE, scheduling information for a downlink data transmission from a base station to the UE and determine a set of transmission opportunities associated with the downlink data transmission within an on duration based on the scheduling information and one or more retransmission parameters configured for the UE. The processor and memory further configured to skip monitoring of one or more first transmission opportunities of the set of transmission opportunities by maintaining a sleep state during the on duration based on the scheduling information and the one or more retransmission parameters configured for the UE. The processor and memory further configured to cause the apparatus to monitor, by the UE in an awake state during the on duration, for a retransmission of the downlink data transmission during one or more second transmission opportunities after the one or more first transmission opportunities of the set of transmission opportunities.

Another apparatus for wireless communications at a UE is described. The apparatus may include means for receiving signaling to identify, by the UE, scheduling information for a downlink data transmission from a base station to the UE and determining a set of transmission opportunities associated with the downlink data transmission within an on duration based on the scheduling information and one or more retransmission parameters configured for the UE. The apparatus may further include means for skipping monitoring of one or more first transmission opportunities of the set of transmission opportunities by maintaining a sleep state during the on duration based on the scheduling information and the one or more retransmission parameters configured for the UE. The apparatus may also include means for monitoring, by the UE in an awake state during the on duration, for a retransmission of the downlink data transmission during one or more second transmission opportunities after the one or more first transmission opportunities of the set of transmission opportunities.

A non-transitory computer-readable medium storing code for wireless communications at a UE is described. The code may include instructions executable by a processor to receive signaling to identify, by the UE, scheduling information for a downlink data transmission from a base station to the UE and determine a set of transmission opportunities associated with the downlink data transmission within an on duration based on the scheduling information and one or more retransmission parameters configured for the UE. The code may further include instructions executable by the processor to skip monitoring of one or more first transmission opportunities of the set of transmission opportunities by maintaining a sleep state during the on duration based on the scheduling information and the one or more retransmission parameters configured for the UE. The code may also include instructions executable by the processor to monitor, by the UE in an awake state during the on duration, for a retransmission of the downlink data transmission during one or more second transmission opportunities after the one or more first transmission opportunities of the set of transmission opportunities.

Some examples of the method, apparatuses, and non-transitory computer-readable medium described herein may further include operations, features, means, or instructions for identifying the one or more retransmission parameters configured for the UE, where the one or more retransmission parameters includes timing information for an initial downlink data retransmission, a retransmission timer associated with downlink retransmissions, a minimum hybrid automatic repeat request (HARQ) response time, or a maximum buffer time.

In some examples of the method, apparatuses, and non-transitory computer-readable medium described herein, determining the set of transmission opportunities may include operations, features, means, or instructions for identifying an initial transmission opportunity for the downlink data transmission, where the initial transmission opportunity may be indicated by the scheduling information. In some examples, determining the set of transmission opportunities may include operations, features, means, or instructions for determining one or more transmission opportunities associated with retransmission of the downlink data transmission based on the one or more retransmission parameters and timing information of the on duration.

In some examples of the method, apparatuses, and non-transitory computer-readable medium described herein, the timing information of the on duration includes a start time of the on duration, an end time of the on duration, or both.

In some examples of the method, apparatuses, and non-transitory computer-readable medium described herein, the timing information for the initial downlink data retransmission corresponds to a number of symbols between a start of the on duration and a timing of a downlink grant for the initial downlink data retransmission.

In some examples of the method, apparatuses, and non-transitory computer-readable medium described herein, the retransmission timer associated with downlink retransmissions corresponds to a number of slots allocated for downlink retransmissions of the downlink data transmission.

Some examples of the method, apparatuses, and non-transitory computer-readable medium described herein may further include operations, features, means, or instructions for skipping monitoring of multiple transmission opportunities of the set of transmission opportunities based on the one or more retransmission parameters, where at least one of the one or more second transmission opportunities may be subsequent to each of the multiple transmission opportunities.

In some examples of the method, apparatuses, and non-transitory computer-readable medium described herein, the one or more first transmission opportunities may include an initial transmission opportunity within the on duration and indicated by the scheduling information, and the one or more second transmission opportunities may include a last transmission opportunity within the on duration.

Some examples of the method, apparatuses, and non-transitory computer-readable medium described herein may further include operations, features, means, or instructions for skipping monitoring of the one or more first transmission opportunities of the set of transmission opportunities based on a traffic type or a quality of service associated with the downlink data transmission.

Some examples of the method, apparatuses, and non-transitory computer-readable medium described herein may further include operations, features, means, or instructions for identifying a flag indicator corresponding to the downlink data transmission, where the flag indicator indicates an estimated arrival rate for the traffic type associated with the downlink data transmission. Some examples of the method, apparatuses, and non-transitory computer-readable medium described herein may further include operations, features, means, or instructions for skipping monitoring of the one or more first transmission opportunities based on the flag indicator or based on the estimated arrival rate for the traffic type.

Some examples of the method, apparatuses, and non-transitory computer-readable medium described herein may further include operations, features, means, or instructions for identifying a setting for the UE associated with a requested or target power savings, determining a power saving level at the UE based on the setting for the UE, and skipping monitoring of the one or more first transmission opportunities based on the determined power saving level.

Some examples of the method, apparatuses, and non-transitory computer-readable medium described herein may further include operations, features, means, or instructions for skipping monitoring of the one or more first transmission opportunities of the set of transmission opportunities based on a current battery power level of the UE.

Some examples of the method, apparatuses, and non-transitory computer-readable medium described herein may further include operations, features, means, or instructions for identifying a channel condition of a channel for the downlink data transmission, and skipping monitoring of the channel during the one or more first transmission opportunities of the set of transmission opportunities based on the channel condition.

Some examples of the method, apparatuses, and non-transitory computer-readable medium described herein may further include operations, features, means, or instructions for reporting a modulation and coding scheme (MCS) to the base station based on the skipping, where the MCS corresponds to a number of transmission opportunities skipped by the UE.

Some examples of the method, apparatuses, and non-transitory computer-readable medium described herein may further include operations, features, means, or instructions for identifying a set of higher layer retransmission parameters and a set of lower layer retransmission parameters associated with the base station, and skipping monitoring of the one or more first transmission opportunities of the set of transmission opportunities based on the set of higher layer retransmission parameters and the set of lower layer retransmission parameters.

In some examples of the method, apparatuses, and non-transitory computer-readable medium described herein, the set of higher layer retransmission parameters includes radio link control (RLC) parameters and the set of lower layer retransmission parameters includes physical layer parameters.

In some examples of the method, apparatuses, and non-transitory computer-readable medium described herein, the set of higher layer retransmission parameters and the set of lower layer retransmission parameters include one or more poll timers, one or more poll prohibit timers, or any combination thereof.

Some examples of the method, apparatuses, and non-transitory computer-readable medium described herein may further include operations, features, means, or instructions for skipping monitoring of the one or more first transmission opportunities of the set of transmission opportunities based on a set of processes to be performed by the UE, where the set of processes includes at least one of a tracking loop update, a mobility update, a beam management procedure, an uplink reporting procedure, or reception of one or more reference signals, or any combination thereof.

In some examples of the method, apparatuses, and non-transitory computer-readable medium described herein, receiving the signaling to identify the scheduling information may include operations, features, means, or instructions for receiving a downlink control channel that includes a downlink grant indicating the scheduling information for the downlink data transmission for the UE.

### BRIEF DESCRIPTION OF THE DRAWINGS

FIG. 1 illustrates an example of a wireless communications system that supports discretionary on duration for wireless devices in accordance with one or more aspects of the present disclosure.

FIG. 2 illustrates an example of a wireless communications system that supports discretionary on duration for wireless devices in accordance with one or more aspects of the present disclosure.

FIG. 3 illustrates an example of a discretionary on configuration that supports discretionary on duration for wireless devices in accordance with one or more aspects of the present disclosure.

FIGS. 4A and 4B illustrate examples of discretionary on configurations that supports discretionary on duration for wireless devices in accordance with one or more aspects of the present disclosure.

FIG. 5 illustrates an example of a process flow that supports discretionary on duration for wireless devices in accordance with one or more aspects of the present disclosure.

FIGS. 6 and 7 show block diagrams of devices that support discretionary on duration for wireless devices in accordance with one or more aspects of the present disclosure.

FIG. 8 shows a block diagram of a communications manager that supports discretionary on duration for wireless devices in accordance with one or more aspects of the present disclosure.

FIG. 9 shows a diagram of a system including a device that supports discretionary on duration for wireless devices in accordance with one or more aspects of the present disclosure.

FIGS. 10 through 12 show flowcharts illustrating methods that support discretionary on duration for wireless devices in accordance with one or more aspects of the present disclosure.

### DETAILED DESCRIPTION

In some wireless communications systems, a base station may configure a UE to operate in a DRX cycle (e.g., connected DRX (CDRX)). In some DRX modes, the UE may maintain receiver circuitry powered on during specified on durations of time (e.g., during an on mode). For example, the UE may enter an on duration for a specified amount of time in order to detect transmissions (e.g., one or more scheduling instances) from the base station. In some examples, scheduling instances transmitted by the base station may include a downlink resource grant, downlink data, or both. In cases where the UE does not detect traffic (e.g., a scheduling instance) from the base station during the on duration, the UE may deactivate the on mode and go to sleep (e.g., power down receiver circuitry) for a specified amount of time (e.g., until the end of a DRX cycle duration).

In cases where the UE detects a scheduling instance during the on duration, the UE may extend the on duration for a period that may be measured by an inactivity timer, before deactivating the on mode and going to sleep. In some examples, the UE may detect a scheduling instance during a shorter on duration, go to sleep, and begin another shorter on duration after a given amount of time has passed (e.g., a short cycle period). The UE may continue sleeping and activating the on mode until completing a given number of on durations (e.g., until a counter is reached). The base station may use on durations to transmit scheduling instances to the UE and to receive feedback (e.g., acknowledgement/negative acknowledgement (ACK/NACK) feedback) from the UE. If the base station receives a negative acknowledgement (NACK) or receives no feedback from the UE regarding a scheduling instance, the base station may retransmit the scheduling instance in a subsequent on duration or a subsequent portion of a current on duration.

In some examples, the UE may employ a discretionary on-duration mode in order to conserve power during DRX operations. For example, in some cases, the UE may discretionarily cut down an on duration by delaying wake-up (e.g., powering on receiver circuitry) or by sleeping during portions of the on duration. Additionally or alternatively, the UE may discretionarily skip one or more shorter on durations. The UE may further use HARQ retransmissions from the base station to receive information that may be missed when sleeping during a configured on duration. In some cases, the UE may evaluate one or more conditions and may determine, based on the one or more conditions, to employ a discretionary on-duration mode. For example, the UE may determine to employ a discretionary on-duration mode based on one or more of a data traffic type, a battery level, a channel condition, a retransmission policy, and physical layer activities (e.g., one or more reference signals configured by the base station).

In a first example of a discretionary on-duration mode, the UE may delay wake-up until a last portion of an on duration. If the base station transmits a scheduling instance in a first portion of the on duration and the UE misses the scheduling instance due to a delayed wake-up, the UE may receive a HARQ retransmission after wake-up in the form of another scheduling instance in a subsequent on duration or a subsequent portion of the on duration. In a second example of a discretionary on-duration mode, the UE may receive a scheduling instance during an on duration, go to sleep during a portion of the on duration, wake up for a specified amount of time, and repeat a sleep and wake-up pattern for a given number of cycles during the on duration. For example, the UE may receive a scheduling instance in a first period of an on duration, may determine to go to sleep, may wake up after a given time and receive another scheduling instance, may determine to go to sleep, and so forth until the end of the on duration. In a third example of a discretionary on-duration mode, the UE may determine to skip one or more shorter on durations (e.g., not perform a wake-up during one or more shorter on durations). For example, the UE may determine to skip a first on duration, a first and a second on duration, one or more middle on durations, etc.

Aspects of the disclosure are initially described in the context of a wireless communications systems. Aspects of the disclosure are further illustrated by and described with reference to on-duration configurations, a process flow, apparatus diagrams, system diagrams, and flowcharts that relate to discretionary on duration for wireless systems.

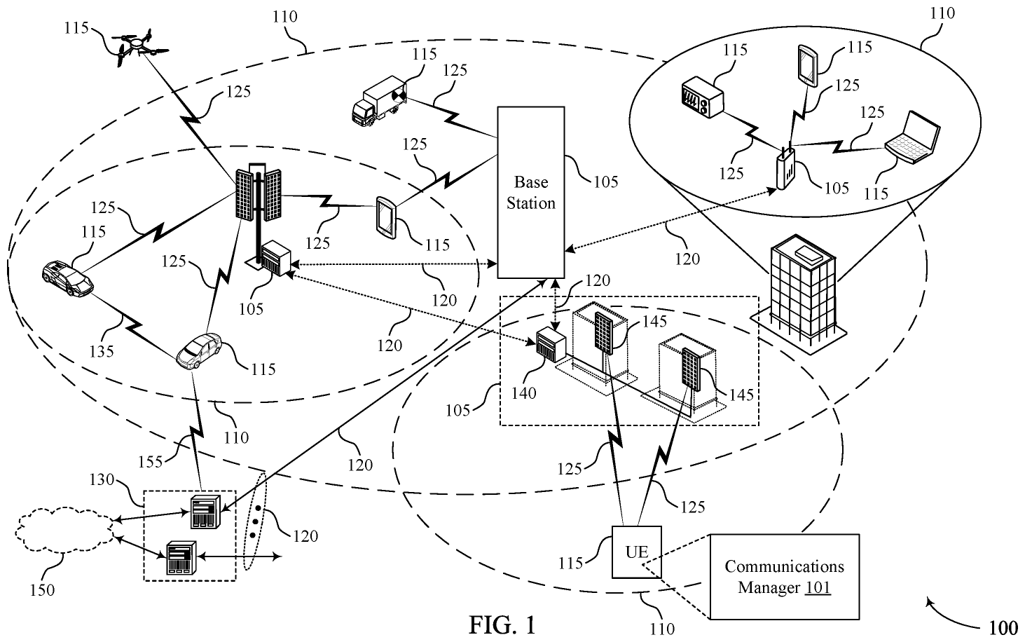

FIG. 1 illustrates an example of a wireless communications system 100 that supports discretionary on duration for wireless devices in accordance with one or more aspects of the present disclosure. The wireless communications system 100 may include base stations 105, UEs 115, and a core network 130. In some examples, the wireless communications system 100 may be a Long Term Evolution (LTE) network, an LTE-Advanced (LTE-A) network, an LTE-A Pro network, or a New Radio (NR) network. In some cases, the wireless communications system 100 may support enhanced broadband communications, ultra-reliable (e.g., mission critical) communications, low latency communications, communications with low-cost and low-complexity devices, or any combination thereof.

Base stations 105 may be dispersed throughout a geographic area to form the wireless communications system 100 and may be devices in different forms or having different capabilities. Base stations 105 and UEs 115 may wirelessly communicate via one or more communication links 125. Each base station 105 may provide a coverage area 110 over which UEs 115 and the base station 105 may establish communication links 125. The coverage area 110 may be an example of a geographic area over which a base station 105 and a UE 115 support the communication of signals according to one or more radio access technologies.

UEs 115 may be dispersed throughout a coverage area 110 of the wireless communications system 100, and each UE 115 may be stationary, or mobile, or both at different times. UEs 115 may be devices in different forms or having different capabilities. Some example UEs 115 are illustrated in FIG. 1. The UEs 115 described herein may be able to communicate with various types of devices, such as other UEs 115, base stations 105, and/or network equipment (e.g., core network nodes, relay devices, integrated access and backhaul (IAB) nodes, or other network equipment), as shown in FIG. 1.

Base stations 105 may communicate with the core network 130, or with one another, or both. For example, base stations 105 may interface with the core network 130 through backhaul links 120 (e.g., via an S1, N2, N3, or other interface). Base stations 105 may communicate with one another over backhaul links 120 (e.g., via an X2, Xn, or other interface) either directly (e.g., directly between base stations 105), or indirectly (e.g., via core network 130), or both. In some examples, backhaul links 120 may be or include one or more wireless links. A UE 115 may communicate with the core network 130 through a communication link 155.

One or more of base stations 105 described herein may include or may be referred to by a person of ordinary skill in the art as a base transceiver station, a radio base station, an access point, a radio transceiver, a NodeB, an eNodeB (eNB), a next-generation NodeB or giga-NodeB (either of which may be referred to as a gNB), a Home NodeB, a Home eNodeB, or other suitable terminology.

A UE 115 may include or may be referred to as a mobile device, a wireless device, a remote device, a handheld device, or a subscriber device, or some other suitable terminology, where the “device” may also be referred to as a unit, a station, a terminal, or a client, among other examples. A UE 115 may also include or may be referred to as a personal electronic device such as a cellular phone, a personal digital assistant (PDA), a tablet computer, a laptop computer, or a personal computer. In some examples, a UE 115 may include or be referred to as a wireless local loop (WLL) station, an Internet of Things (IoT) device, an Internet of Everything (IoE) device, a machine type communications (MTC) device, or the like, which may be implemented in various objects such as appliances, vehicles, meters, or the like.

The UEs 115 described herein may be able to communicate with various types of devices, such as other UEs 115 that may sometimes act as relays as well as base stations 105 and network equipment including macro eNBs or gNBs, small cell eNBs or gNBs, relay base stations, and the like, as shown in FIG. 1.

UEs 115 and base stations 105 may wirelessly communicate with one another via one or more communication links 125 over one or more carriers. The term “carrier” may refer to a set of radio frequency spectrum resources having a defined physical layer structure for supporting communication links 125. For example, a carrier used for a communication link 125 may include a portion of a radio frequency spectrum band (e.g., a bandwidth part (BWP)) that is operated according to physical layer channels for a given radio access technology (e.g., LTE, LTE-A, LTE-A Pro, NR). Each physical layer channel may carry acquisition signaling (e.g., synchronization signals, system information), control signaling that coordinates operation for the carrier, user data, or other signaling. The wireless communications system 100 may support communication with a UE 115 using carrier aggregation or multi-carrier operation. A UE 115 may be configured with multiple downlink component carriers and one or more uplink component carriers according to a carrier aggregation configuration. Carrier aggregation may be used with both frequency division duplexing (FDD) and time division duplexing (TDD) component carriers.

Signal waveforms transmitted over a carrier may be made up of multiple subcarriers (e.g., using multi-carrier modulation (MCM) techniques such as orthogonal frequency division multiplexing (OFDM) or discrete Fourier transform spread OFDM (DFT-S-OFDM)). In a system employing MCM techniques, a resource element may consist of one symbol period (e.g., a duration of one modulation symbol) and one subcarrier, where the symbol period and subcarrier spacing are inversely related. The number of bits carried by each resource element may depend on the modulation scheme (e.g., the order of the modulation scheme, the coding rate of the modulation scheme, or both). Thus, the more resource elements that a UE 115 receives and the higher the order of the modulation scheme, the higher the data rate may be for the UE 115. A wireless communications resource may refer to a combination of a radio frequency spectrum resource, a time resource, and a spatial resource (e.g., spatial layers or beams), and the use of multiple spatial layers may further increase the data rate or data integrity for communications with a UE 115.

Time intervals for base stations 105 or UEs 115 may be expressed in multiples of a basic time unit which may, for example, refer to a sampling period of T_{S}=1/(Δfₘₐₓ·N_{f}) seconds, where Δfₘₐₓ may represent the maximum supported subcarrier spacing, and N_{f} may represent the maximum supported discrete Fourier transform (DFT) size. Time intervals of a communications resource may be organized according to radio frames each having a specified duration (e.g., 10 milliseconds (ms)). Each radio frame may be identified by a system frame number (SFN) (e.g., ranging from 0 to 1023).

Each frame may include multiple consecutively numbered subframes or slots, and each subframe or slot may have the same duration. In some cases, a frame may be divided into subframes, and each subframe may be further divided into a number of slots. Alternatively, each frame may include a variable number of slots, and the number of slots may depend on subcarrier spacing. Each slot may include a number of symbol periods (e.g., depending on the length of the cyclic prefix prepended to each symbol period). In some wireless communications systems 100, a slot may further be divided into multiple mini-slots containing one or more symbols. Excluding the cyclic prefix, each symbol period may contain one or more (e.g., N_{f}) sampling periods. The duration of a symbol period may depend on the subcarrier spacing or frequency band of operation.

A subframe, a slot, a mini-slot, or a symbol may be the smallest scheduling unit of the wireless communications system 100 and may be referred to as a transmission time interval (TTI). In some cases, the TTI duration (that is, the number of symbol periods in a TTI) may be variable. Additionally or alternatively, the smallest scheduling unit of the wireless communications system 100 may be dynamically selected (e.g., in bursts of shortened TTIs (sTTIs)).

Physical channels may be multiplexed on a carrier according to various techniques. A physical control channel and a physical data channel may be multiplexed on a downlink carrier, for example, using time division multiplexing (TDM) techniques, frequency division multiplexing (FDM) techniques, or hybrid TDM-FDM techniques. A control region (e.g., a control resource set (CORESET)) for a physical control channel may be defined by a number of symbol periods and may extend across the system bandwidth or a subset of the system bandwidth of the carrier. One or more control regions (e.g., CORESETs) may be configured for a set of UEs 115. For example, UEs 115 may monitor or search control regions for control information according to one or more search space sets, and each search space set may include one or multiple control channel candidates in one or more aggregation levels arranged in a cascaded manner. An aggregation level for a control channel candidate may refer to a number of control channel resources (e.g., control channel elements (CCEs)) associated with encoded information for a control information format having a given payload size. Search space sets may include common search space sets configured for sending control information to multiple UEs 115 and UE-specific search space sets for sending control information to a specific UE 115.

In some examples, a base station 105 may be movable and therefore provide communication coverage for a moving geographic coverage area 110. In some examples, different geographic coverage areas 110 associated with different technologies may overlap, but the different geographic coverage areas 110 may be supported by the same base station 105. In other examples, overlapping geographic coverage areas 110 associated with different technologies may be supported by different base stations 105. The wireless communications system 100 may include, for example, a heterogeneous network in which different types of base stations 105 provide coverage for various geographic coverage areas 110 using the same or different radio access technologies.

Some UEs 115 may be configured to employ operating modes that reduce power consumption, such as half-duplex communications (e.g., a mode that supports one-way communication via transmission or reception, but not transmission and reception simultaneously). In some examples, half-duplex communications may be performed at a reduced peak rate. Other power conservation techniques for UEs 115 include entering a power saving deep sleep mode when not engaging in active communications, operating over a limited bandwidth (e.g., according to narrowband communications), or a combination of these techniques. For example, some UEs 115 may be configured for operation using a narrowband protocol type that is associated with a predefined portion or range (e.g., set of subcarriers or resource blocks (RBs)) within a carrier, within a guard-band of a carrier, or outside of a carrier.

The wireless communications system 100 may be configured to support ultra-reliable communications or low-latency communications, or various combinations thereof. For example, the wireless communications system 100 may be configured to support ultra-reliable low-latency communications (URLLC) or mission critical communications. UEs 115 may be designed to support ultra-reliable, low-latency, or critical functions (e.g., mission critical functions). Ultra-reliable communications may include private communication or group communication and may be supported by one or more mission critical services such as mission critical push-to-talk (MCPTT), mission critical video (MCVideo), or mission critical data (MCData). Support for mission critical functions may include prioritization of services, and mission critical services may be used for public safety or general commercial applications. The terms ultra-reliable, low-latency, mission critical, and ultra-reliable low-latency may be used interchangeably herein.

In some cases, a UE 115 may also be able to communicate directly with other UEs 115 over a device-to-device (D2D) communication link 135 (e.g., using a peer-to-peer (P2P) or D2D protocol). One or more UEs 115 utilizing D2D communications may be within the geographic coverage area 110 of a base station 105. Other UEs 115 in such a group may be outside the geographic coverage area 110 of a base station 105 or be otherwise unable to receive transmissions from a base station 105. In some cases, groups of UEs 115 communicating via D2D communications may utilize a one-to-many (1:M) system in which each UE 115 transmits to every other UE 115 in the group. In some examples, a base station 105 facilitates the scheduling of resources for D2D communications. In other cases, D2D communications are carried out between UEs 115 without the involvement of a base station 105.

The core network 130 may provide user authentication, access authorization, tracking, Internet Protocol (IP) connectivity, and other access, routing, or mobility functions. The core network 130 may be an evolved packet core (EPC) or 5G core (5GC), which may include at least one control plane entity that manages access and mobility (e.g., a mobility management entity (MME), an access and mobility management function (AMF)) and at least one user plane entity that routes packets or interconnects to external networks (e.g., a serving gateway (S-GW), a Packet Data Network (PDN) gateway (P-GW), a user plane function (UPF)). The control plane entity may manage non-access stratum (NAS) functions such as mobility, authentication, and bearer management for UEs 115 served by base stations 105 associated with the core network 130. User IP packets may be transferred through the user plane entity, which may provide IP address allocation as well as other functions. The user plane entity may be connected to the network operators IP services 150. The operators IP services 150 may include access to the Internet, Intranet(s), an IP Multimedia Subsystem (IMS), or a Packet-Switched Streaming Service.

Some of the network devices, such as a base station 105, may include subcomponents such as an access network entity 140, which may be an example of an access node controller (ANC). Each access network entity 140 may communicate with UEs 115 through a number of other access network transmission entities 145, which may be referred to as radio heads, smart radio heads, or transmission/reception points (TRPs). Each access network transmission entity 145 may include one or more antenna panels. In some configurations, various functions of each access network entity 140 or base station 105 may be distributed across various network devices (e.g., radio heads and ANCs) or consolidated into a single network device (e.g., a base station 105).

The wireless communications system 100 may operate using one or more frequency bands, for example, in the range of 300 megahertz (MHz) to 300 gigahertz (GHz). For example, the region from 300 MHz to 3 GHz is known as the ultra-high frequency (UHF) region or decimeter band, since the wavelengths range from approximately one decimeter to one meter in length. UHF waves may be blocked or redirected by buildings and environmental features, but the waves may penetrate structures sufficiently for a macro cell to provide service to UEs 115 located indoors. Transmission of UHF waves may be associated with smaller antennas and shorter ranges (e.g., less than 100 kilometers) compared to transmission using the smaller frequencies and longer waves of the high frequency (HF) or very high frequency (VHF) portion of the spectrum below 300 MHz.

The wireless communications system 100 may utilize both licensed and unlicensed radio frequency spectrum bands. For example, the wireless communications system 100 may employ License Assisted Access (LAA), LTE-Unlicensed (LTE-U) radio access technology, or NR technology in an unlicensed band such as the 5 GHz industrial, scientific, and medical (ISM) band. When operating in unlicensed radio frequency spectrum bands, devices such as base stations 105 and UEs 115 may employ carrier sensing for collision detection and avoidance. In some cases, operations in unlicensed bands may be based on a carrier aggregation configuration in conjunction with component carriers operating in a licensed band (e.g., LAA). Operations in unlicensed spectrum may include downlink transmissions, uplink transmissions, P2P transmissions, D2D transmissions, or the like.

A base station 105 or UE 115 may be equipped with multiple antennas, which may be used to employ techniques such as transmit diversity, receive diversity, multiple-input multiple-output (MIMO) communications, or beamforming. The antennas of a base station 105 or UE 115 may be located within one or more antenna arrays or antenna panels, which may support MIMO operations or transmit or receive beamforming. For example, one or more base station antennas or antenna arrays may be co-located at an antenna assembly, such as an antenna tower. In some cases, antennas or antenna arrays associated with a base station 105 may be located in diverse geographic locations. A base station 105 may have an antenna array with a number of rows and columns of antenna ports that the base station 105 may use to support beamforming of communications with a UE 115. Likewise, a UE 115 may have one or more antenna arrays that may support various MIMO or beamforming operations. Additionally or alternatively, an antenna panel may support radio frequency beamforming for a signal transmitted via an antenna port.

Beamforming, which may also be referred to as spatial filtering, directional transmission, or directional reception, is a signal processing technique that may be used at a transmitting device or a receiving device (e.g., a base station 105 or a UE 115) to shape or steer an antenna beam (e.g., a transmit beam, a receive beam) along a spatial path between the transmitting device and the receiving device. Beamforming may be achieved by combining the signals communicated via antenna elements of an antenna array such that some signals propagating at particular orientations with respect to an antenna array experience constructive interference while others experience destructive interference. The adjustment of signals communicated via the antenna elements may include a transmitting device or a receiving device applying certain amplitude offsets, phase offsets, or both to signals carried via the antenna elements associated with the device. The adjustments associated with each of the antenna elements may be defined by a beamforming weight set associated with a particular orientation (e.g., with respect to the antenna array of the transmitting device or receiving device, or with respect to some other orientation).

The wireless communications system 100 may be a packet-based network that operates according to a layered protocol stack. In the user plane, communications at the bearer or Packet Data Convergence Protocol (PDCP) layer may be IP-based. An RLC layer may perform packet segmentation and reassembly to communicate over logical channels. A Medium Access Control (MAC) layer may perform priority handling and multiplexing of logical channels into transport channels. The MAC layer may also use error detection techniques, error correction techniques, or both to support retransmissions at the MAC layer to improve link efficiency. In the control plane, the Radio Resource Control (RRC) protocol layer may provide establishment, configuration, and maintenance of an RRC connection between a UE 115 and a base station 105 or core network 130 supporting radio bearers for user plane data. At the Physical layer, transport channels may be mapped to physical channels.

UEs 115 and base stations 105 may support retransmissions of data to increase the likelihood that data is received successfully. HARQ feedback is one technique for increasing the likelihood that data is received correctly over a communication link 125. HARQ may include a combination of error detection (e.g., using a cyclic redundancy check (CRC)), forward error correction (FEC), and retransmission (e.g., automatic repeat request (ARQ)). HARQ may improve throughput at the MAC layer in poor radio conditions (e.g., low signal-to-noise conditions). In some cases, a device may support same-slot HARQ feedback, where the device may provide HARQ feedback in a specific slot for data received in a previous symbol in the slot. In other cases, the device may provide HARQ feedback in a subsequent slot, or according to some other time interval.

In some wireless communications systems, a base station 105 may configure a UE 115 to operate in a DRX cycle (e.g., CDRX). For example, a base station 105 may employ a CDRX cycle (e.g., with a long cycle and optionally with multiple short cycles within the long cycle) to flexibly serve a UE 115 that may have a bursty (e.g., intermittent) traffic pattern. In some CDRX modes, the UE 115 may enter an on duration for a specified amount of time in order to detect transmissions (e.g., one or more scheduling instances) from the base station 105. In cases where the UE 115 does not detect traffic (e.g., a scheduling instance) from the base station 105 during the on duration, the UE 115 may quit the on mode and go back to sleep for a specified amount of time (e.g., until the end of a DRX cycle duration). In cases where the UE detects a scheduling instance during the on duration, the UE may extend the on duration for a period that may be measured by an inactivity timer, before deactivating the on mode and going to sleep. In some examples, the UE may detect a scheduling instance during a shorter on duration, go to sleep, begin another shorter on duration after a defined amount of time has passed (e.g., a short cycle period), and continue a cycle of sleep periods and on durations until completing a given number of on durations (e.g., until a counter is reached).

In some examples, the UE 115 may employ a discretionary on-duration mode in order to conserve power during a DRX cycle. For example, in some cases, the UE 115 may discretionarily cut down an on duration by delaying wake-up or by sleeping during portions of the on duration. Additionally or alternatively, the UE 115 may discretionarily skip one or more shorter on durations. The UE 115 may use HARQ retransmissions from the base station 105 to receive information that may be missed when sleeping during a configured on duration. In some cases, the UE 115 may evaluate one or more conditions and may determine, based on the one or more conditions, to employ a discretionary on-duration mode.

UEs 115 may include a communications manager 101, which may identify scheduling information for a downlink data transmission from a base station to a UE 115 and determine a set of transmission opportunities associated with the downlink data transmission within an on duration based on the scheduling information and one or more retransmission parameters configured for the UE 115. The communications manager 101 may further skip monitoring of one or more first transmission opportunities of the set of transmission opportunities by maintaining a sleep state during the on duration based on the scheduling information and the one or more retransmission parameters configured for the UE 115. The communications manager 101 may also monitor, in an awake state during the on duration, for a retransmission of the downlink data transmission during one or more second transmission opportunities after the one or more first transmission opportunities of the set of transmission opportunities.

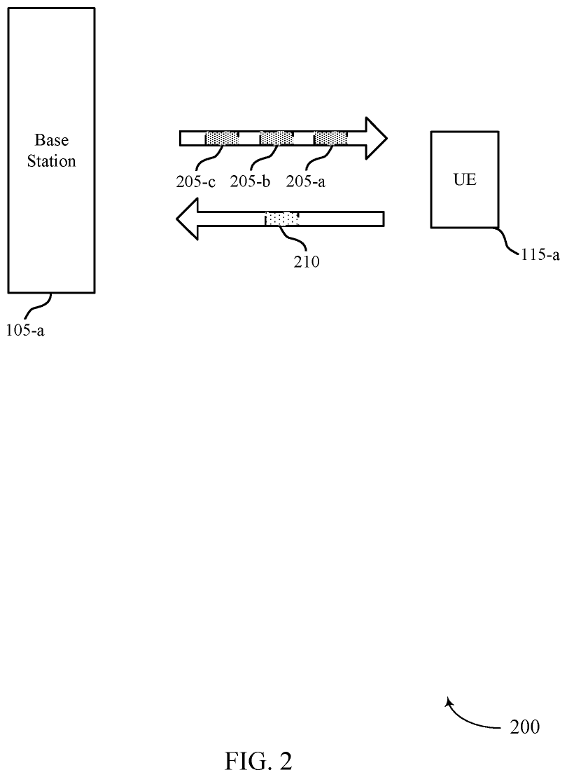

FIG. 2 illustrates an example of a wireless communications system 200 that supports discretionary on duration for wireless devices in accordance with one or more aspects of the present disclosure. In some examples, wireless communications system 200 may implement aspects of wireless communications system 100 and may include a UE 115-a and a base station 105-a, which may be examples of a UE 115 and a base station 105 described with reference to FIG. 1. In some cases, base station 105-a may configure UE 115-a to operate on a long cycle and/or short cycle CDRX mode, and UE 115-a may determine to monitor for communications from base station 105-a according to a discretionary on configuration.

In some examples, base station 105-a may configure UE 115-a to operate on a long cycle CDRX. As such, UE 115-a may initiate and maintain an on mode for a specified long cycle on duration. In cases where UE 115-a does not detect traffic (e.g., scheduling instances 205) from base station 105-a during the on duration, UE 115-a may deactivate the on mode and go to sleep until the end of a long cycle CDRX duration. In cases where UE 115-a detects a scheduling instance 205 during the on duration, UE 115-a may extend the on duration for a probation period that may be measured by an inactivity timer, before deactivating the on mode and going back to sleep. In some examples, scheduling instances 205 transmitted by base station 105-a during an on duration may include a downlink resource grant (e.g., transmitted on a physical downlink control channel (PDCCH)), downlink data (e.g., transmitted on a physical downlink shared channel (PDSCH)), or both.

In some examples, base station 105-a may configure UE 115-a to operate on a short cycle CDRX (e.g., within a long cycle CDRX). As such, UE 115-a may initiate and maintain an on mode for a specified short cycle on duration. In cases where UE 115-a does not detect a scheduling instance 205 from base station 105-a during the on duration, UE 115-a may deactivate the on mode and go back to sleep (e.g., until the end of a long cycle CDRX duration). In cases where UE 115-a detects a scheduling instance 205 during the on duration, UE 115-a may extend the on time for a probation period that may be measured by an inactivity timer, before deactivating the on mode and going back to sleep. Additionally, if a scheduling instance 205 is received in short cycle CDRX operation, UE 115-a may go to sleep and then follow up with another short cycle on duration after an amount of time has passed (e.g., a short cycle period). UE 115-a may continue a cycle of sleep periods and short cycle on durations until completing a given number of short cycle on durations (e.g., until a short cycle CDRX counter is reached).

Base station 105-a may use on durations to transmit scheduling instances 205 to UE 115-a and receive feedback (e.g., ACK/NACK feedback) from UE 115-a. If base station 105-a receives a NACK or receives no feedback from UE 115-a regarding a scheduling instance 205, base station 105-a may retransmit the scheduling instance 205 in a subsequent on duration or a subsequent portion of a current on duration.

In some cases, a short cycle CDRX mode may have a shorter total on duration than a purely long cycle CDRX mode and may therefore save power at UE 115-a. For example, a short cycle CDRX may divide a long cycle CDRX into smaller sections (e.g., each short cycle on duration), and base station 105-a may serve UE 115-a with the same percentage service time as with a long cycle CDRX. In some short cycle CDRX modes, base station 105-a may transmit an indication of CDRX activities to UE 115-a within a first short cycle on duration (e.g., within a scheduling instance 205). In cases where UE 115-a may miss the first short cycle on duration (e.g., due to CDRX warm-up, wireless channel variation, etc.), UE 115-a and base station 105-a may use ARQ and/or HARQ retransmissions in follow up short cycle on durations to ensure UE 115-a receives any information missed from the first short cycle. For example, follow up short cycle on durations may be used as opportunities for UE 115-a to receive missed scheduling instances 205 transmitted from base station 105-a during the first short cycle on duration. In some cases, base station 105-a may retransmit the missed scheduling instance 205 no earlier than a specified number of symbols (e.g., specified by a drx-HARQ-RTT-timer field) and no later than a specified number of TTIs (e.g., specified by a drx-Retransmission Timer field).

In some cases, UE 115-a may employ a discretionary on-duration mode to discretionarily cut down long cycle on duration by delaying wake up or by sleeping during portions of an on duration. Additionally or alternatively, UE 115-a may discretionarily skip one or more short cycle on durations. By employing a discretionary on-duration mode, UE 115-a may use HARQ retransmissions from base station 105-a (e.g., in follow up short cycle on durations or during an inactivity timer of a long cycle on duration) to receive missed information (e.g., missed scheduling instances 205). In some examples, UE 115-a may employ a discretionary CDRX on-duration mode when expected power savings from a shorter total on duration may outweigh delays or other effects associated with shortening a total on duration.

In some cases, UE 115-a may evaluate one or more conditions and may determine, based on the one or more conditions, to employ a discretionary CDRX on-duration mode to conserve power during a CDRX cycle (e.g., short cycle and/or long cycle). For example, UE 115-a may determine to conserve power based on one or more of a data traffic type, a battery level (e.g., of UE 115-a), a channel condition, a retransmission policy, and physical layer activities (e.g., one or more reference signals configured by base station 105-a).

In some cases, a data traffic type may include a bursty traffic characterization, where data traffic may be received by UE 115-a at a lower arrival rate. The data traffic type may be indicated in an upper layer logical channel quality of service (QoS) attribute or by a flag set by an arrival rate in a queueing model of different traffic types. In some cases, a data traffic type may have a lower arrival rate than a ratio of on time to total time in a CDRX cycle, which may indicate that average power savings in on durations of a CDRX cycle in which no grants are transmitted may outweigh a delay of receiving scheduling instances via HARQ retransmissions. As such, UE 115-a may determine to employ a discretionary CDRX on-duration mode. In another example, a battery level may drop below a threshold level and UE 115-a may determine to employ a discretionary CDRX on-duration mode. Additionally or alternatively, UE 115-a may determine to employ a discretionary CDRX on-duration mode when a channel condition is above a channel quality threshold, such that HARQ retransmission reliability is increased.

UE 115-a may also determine to employ a discretionary CDRX on-duration mode based on a retransmission policy of base station 105-a. For example, UE 115-a may consider a HARQ timeline and higher-layer ARQ parameters implemented by base station 105-a and may determine that a skipped on duration falls within a lower layer buffering time or that a high-layer ARQ delay is within traffic type tolerance. If a discretionary CDRX on-duration mode misses a physical layer buffering time or an RLC delay at base station 105-a, HARQ retransmissions may take place at a higher layer with a different order of delays. In some cases, UE 115-a may determine to employ a discretionary CDRX on-duration mode based on channel state feedback. For example, UE 115-a may discretionally shorten on durations and may miss HARQ subpackets. Accordingly, UE 115-a may lower a per-subpacket block error rate when skipping on durations by biasing channel quality information reporting and reporting a lower MCS level.

UE 115-a may also determine to employ a discretionary CDRX on-duration mode based on physical layer activities, such as uplink report transmissions or physical layer reference signals for tracking loop updates, mobility measurement, or beam measurement. When considering these or other physical layer activities, UE 115-a may introduce another level of opportunistic discretionary CDRX on-duration mode (e.g., may cut on durations based on a specified percentage of time) to maintain specified levels of performance.

In a first example of a discretionary on-duration mode, UE 115-a may delay wake-up until a last portion of an on duration. For example, if UE 115-a is configured with an on duration of 10 ms, UE 115-a may delay wake-up until a last 8 ms or a last 6 ms of the on duration. If base station 105-a transmits a scheduling instance, such as scheduling instance 205-a, in a first portion of the on duration and UE 115-a misses scheduling instance 205-a due to a delayed wake-up, UE 115-a may receive one or more HARQ retransmissions after wake-up in the form of scheduling instances 205-b and/or 205-c.

In a second example of a discretionary on-duration mode, if UE 115-a is configured for long cycle CDRX (e.g., and not configured for short cycle CDRX), UE 115-a may mimic a short cycle CDRX by going back to sleep for a defined time period after receiving a scheduling instance, and repeating a sleep and wake-up pattern for a specified number of cycles within an on duration. For example, UE 115-a may receive a scheduling instance 205-a in a first period of an on duration, may determine to go back to sleep, may wake up after a given time and receive scheduling instance 205-b, may determine to go back to sleep, and may wake up after a given time and receive scheduling instance 205-c.

In a third example of a discretionary on-duration mode, UE 115-a may determine to skip one or more short cycle on durations (e.g., not perform a wake-up during one or more short cycle on durations), such as a first short cycle on duration, a first and a second short cycle on duration, one or more middle short cycle on durations, etc. For example, UE 115-a may receive scheduling instance 205-a and may transmit NACK feedback to base station 105-a (e.g., due to an unsuccessfully received message). In some cases, UE 115-a may determine to skip a second short cycle on duration and may miss scheduling instance 205-b (e.g., a HARQ retransmission). UE 115-a may determine to wake up for following short cycle on durations and may receive another HARQ retransmission within scheduling instance 205-c (e.g., transmitted because no feedback was received from scheduling instance 205-b).

UE 115-a may transmit HARQ feedback for any received scheduling instances 205-a, 205-b, and/or 205-c to base station 105-a in one or more feedback messages 210 (e.g., HARQ feedback messages). Base station 105-a may use the HARQ feedback, along with any missing HARQ feedback, to determine whether UE 115-a has missed or otherwise been unable to decode any scheduling instances 205 (e.g., failed scheduling instance(s) 205), and may retransmit any failed scheduling instance 205.

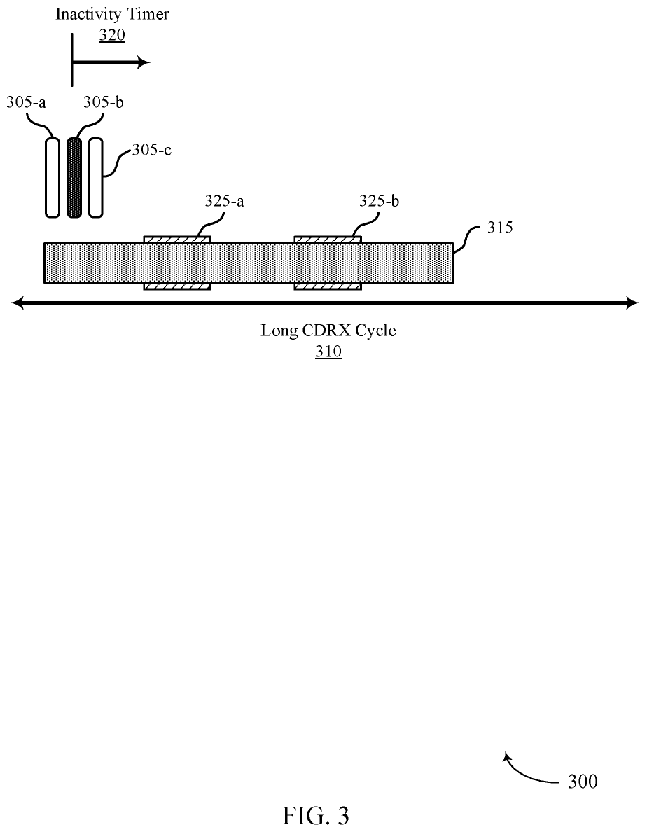

FIG. 3 illustrates an example of a discretionary on configuration 300 that supports discretionary on duration for wireless devices in accordance with one or more aspects of the present disclosure. In some examples, discretionary on configuration 300 may implement aspects of wireless communications systems 100 or 200 and may be implemented by a UE 115 or a base station 105, as described with reference to FIGS. 1 and 2. For example, the base station 105 may configure the UE 115 to operate in a long cycle CDRX mode, and the UE 115 may monitor for communications from the base station 105 according to discretionary on configuration 300.

When operating in a long cycle CDRX mode, the UE 115 may initiate and maintain an on mode for a specified long cycle on duration 315. In cases where the UE 115 does not detect a scheduling instance 305 from the base station 105 during the on duration 315, UE 115 may deactivate the on mode and go back to sleep until the end of a long cycle CDRX duration 310. In some examples, a scheduling instance 305 may include a downlink resource grant (e.g., transmitted on a PDCCH), downlink data (e.g., transmitted on a PDSCH), or both. In cases where the UE 115 detects, during the on duration 315, a scheduling instance 305 intended for the UE 115 (e.g., scheduling instance 305-b), the UE 115 may extend the on time for the on duration 315, which extension may last for a length of an inactivity timer 320 (e.g., started when scheduling instance 305-b is received). After on duration 315, the UE 115 may deactivate the on mode and go back to sleep until the end of long cycle CDRX duration 310.

In some cases, the UE 115 may evaluate one or more conditions, as described with reference to FIG. 2, and may determine, based on the conditions, to employ discretionary on configuration 300 to conserve power during the long CDRX cycle. For example, the UE 115 may employ discretionary on configuration 300 when expected power savings from a shorter total on duration may outweigh delays or other effects caused by shortening a total on duration.

In a first example of discretionary on configuration 300, the UE 115 may mimic a short cycle CDRX by going back to sleep for sleep periods 325 during the on duration 315. For example, the UE 115 may receive scheduling instance 305-b in a first portion of the on duration 315 and may determine to go back to sleep during sleep period 325-a. The UE 115 may wake up at the end of sleep period 325-a and monitor for other scheduling instances 305, may determine to go back to sleep during sleep period 325-b, and may wake up at the end of sleep period 325-b and monitor for other scheduling instances 305. In some cases, other scheduling instances 305 may include additional information compared to scheduling instance 305-b, or in some cases, other scheduling instances 305 may represent HARQ retransmissions of information from scheduling instance 305-b (e.g., retransmitted due to a NACK feedback or due to no feedback).

In a second example of discretionary on configuration 300, if the UE 115 completes a HARQ process and successfully receives scheduling instance 305-b, the UE 115 may determine to go back to sleep during sleep period 325-a, until the end of a next HARQ process. The UE 115 may determine a time corresponding to a last HARQ retransmission of the next HARQ process (e.g., corresponding to a maximum number of retransmissions minus one, multiplied by a field drx-HARQ-RTT-TimerDL) and may determine to sleep for the determined time (e.g., for sleep period 325-a). Accordingly, the UE may sleep through a first scheduling instance 305 and following HARQ retransmissions, and may wake up for a last HARQ retransmission (e.g., a scheduling instance 305 transmitted after the end of sleep period 325-a). The UE 115 may also perform this process during subsequent portions of on duration 315, and may for example, go to sleep during sleep period 325-b, miss one or more scheduling instances 305, and wake up for a last HARQ retransmission that takes place after the end of sleep period 325-b.

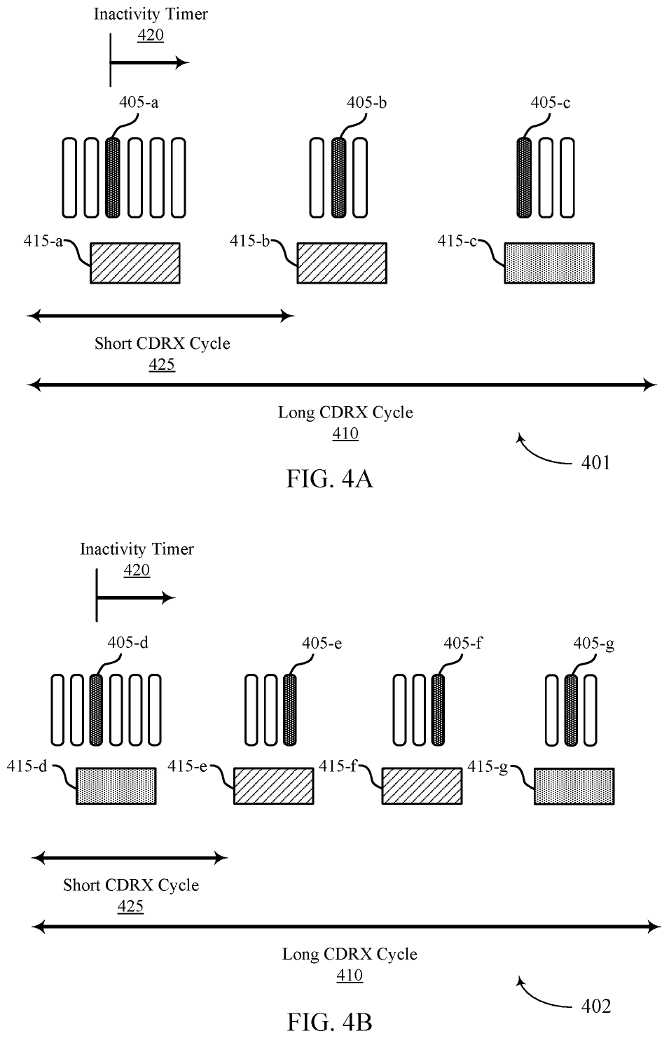

FIG. 4A illustrates an example of a discretionary on configuration 401 that supports discretionary on duration for wireless devices in accordance with one or more aspects of the present disclosure. In some examples, discretionary on configuration 401 may implement aspects of wireless communications systems 100 or 200 and may be implemented by a UE 115 and a base station 105, as described with reference to FIGS. 1-3. For example, the base station 105 may configure the UE 115 to operate in a long cycle CDRX mode and/or a short cycle CDRX mode, and the UE 115 may monitor for communications from the base station 105 according to discretionary on configuration 401.

In some examples, the UE 115 may initiate and maintain an on mode during an on duration 415-a. If the UE 115 does not detect a scheduling instance 405 from the base station 105 during on duration 415-a, UE 115 may deactivate the on mode and go back to sleep until the end of a long cycle CDRX duration 410. If the UE 115 detects, during on duration 415-a, a scheduling instance 405 intended for the UE 115 (e.g., scheduling instance 405-a), the UE 115 may extend the on time for on duration 415-a, which may last for a length of an inactivity timer 420 (e.g., started when scheduling instance 405-a is received). After on duration 415-a, the UE 115 may deactivate the on mode and go back to sleep.

If scheduling instance 405-a is received in short cycle CDRX mode, the UE 115 may follow up on duration 415-a with another on duration 415-b (e.g., after a short CDRX cycle duration 425). UE 115-a may continue a cycle of sleep periods between on durations 415 until completing a given number of on durations 415 (e.g., until a short cycle CDRX counter is reached). The base station 105 may use on durations 415 to transmit scheduling instances 405 to the UE 115 and to receive feedback (e.g., ACK/NACK feedback) from the UE 115. If the base station 105 receives a NACK or receives no feedback from the UE 115 related to a scheduling instance 405, the base station 105 may retransmit the scheduling instance 405 during a subsequent on duration 415.

In some cases, the UE 115 may evaluate one or more conditions, as described with reference to FIG. 2, and may determine, based on the conditions, to employ discretionary on configuration 401 to further conserve power during CDRX operation. For example, the UE 115 may employ discretionary on configuration 401 when expected power savings from a shorter total on duration may outweigh delays or other effects caused by shortening a total on duration.

In a first example of discretionary on configuration 401, the UE 115 may delay wake-up until a last portion of the long cycle CDRX duration 410. For example, the UE 115 may sleep during on durations 415-a and 415-b (e.g., and may sleep during any sleep periods between on durations 415-a and 415-b). If the base station 105 transmits a scheduling instance 405-a during on duration 415-a, the UE 115 may miss scheduling instance 405-a due to the delayed wake-up. The base station 105 may not receive feedback for scheduling instance 405-a and may determine to retransmit the information from scheduling instance 405-a to the UE 115 using scheduling instance 405-b. The UE 115 may also miss scheduling instance 405-b during on duration 415-b due to the delayed wake-up. The base station 105 may therefore not receive feedback for scheduling instance 405-b and may determine to retransmit the information from scheduling instance 405-b to the UE 115 using scheduling instance 405-c. The UE 115 may wake up for on duration 415-c, may attempt to receive the retransmission in the form of scheduling instance 405-c, and may transmit corresponding feedback to the base station 105.

In a second example of discretionary on configuration 401, the UE 115 may determine to skip one or more on durations 415 (e.g., not perform a wake-up during one or more short cycle on durations 415), such as on durations 415-a and 415-b. If the base station 105 transmits a scheduling instance 405-a during on duration 415-a, the UE 115 may miss scheduling instance 405-a due to the determination to skip on duration 415-a. The base station 105 may not receive feedback for scheduling instance 405-a and may determine to retransmit the information from scheduling instance 405-a to the UE 115 using scheduling instance 405-b. The UE 115 may also miss scheduling instance 405-b during on duration 415-b due to the determination to skip on duration 415-b. The base station 105 may therefore not receive feedback for scheduling instance 405-b and may determine to retransmit the information from scheduling instance 405-b to the UE 115 using scheduling instance 405-c. The UE 115 may wake up for on duration 415-c, may attempt to receive the retransmission in the form of scheduling instance 405-c, and may transmit corresponding feedback to the base station 105.

FIG. 4B illustrates an example of a discretionary on configuration 402 that supports discretionary on duration for wireless devices in accordance with one or more aspects of the present disclosure. In some examples, discretionary on configuration 402 may implement aspects of wireless communications systems 100 or 200 and may be implemented by a UE 115 and a base station 105, which may be examples of a UE 115 and a base station 105 described with reference to FIGS. 1-3. For example, the base station 105 may configure the UE 115 to operate in a long cycle CDRX mode and/or a short cycle CDRX mode, and the UE 115 may monitor for communications from the base station 105 according to discretionary on configuration 402.

In some examples, the UE 115 may initiate and maintain an on mode during an on duration 415-d. In cases where the UE 115 does not detect a scheduling instance 405 from the base station 105 during on duration 415-d, UE 115 may deactivate the on mode and go back to sleep until the end of a long cycle CDRX duration 410. In cases where the UE 115 detects, during on duration 415-d, a scheduling instance 405-d intended for the UE 115, the UE 115 may extend the on time for on duration 415-d, which may last for a length of an inactivity timer 420 (e.g., started when scheduling instance 405-d is received). After on duration 415-d, the UE 115 may deactivate the on mode and go back to sleep.

Additionally, if scheduling instance 405-d is received in short cycle CDRX mode, the UE 115 may follow up on duration 415-d with another on duration 415-e (e.g., after a short CDRX cycle duration 425). UE 115-d may continue a cycle of sleep periods and on durations 415 until completing a given number of on durations 415 (e.g., until a short cycle CDRX counter is reached). The base station 105 may use on durations 415 to transmit scheduling instances 405 to the UE 115 and to receive feedback (e.g., ACK/NACK feedback) from the UE 115. If the base station 105 receives a NACK or receives no feedback from the UE 115 related to a scheduling instance 405, the base station 105 may retransmit the scheduling instance 405 in a subsequent on duration 415.

In some cases, the UE 115 may evaluate one or more conditions, as described with reference to FIG. 2, and may determine, based on the conditions, to employ discretionary on configuration 402 to further conserve power during CDRX operation. For example, the UE 115 may employ discretionary on configuration 402 when expected power savings from a shorter total on duration may outweigh delays or other effects caused by shortening a total on duration.

In one example of discretionary on configuration 402, the UE 115 may determine to skip one or more on durations 415 (e.g., not perform a wake-up during one or more short cycle on durations 415), such as on durations 415-e and 415-f. In some examples, the UE 115 may receive scheduling instance 405-d and may transmit NACK feedback to the base station 105 (e.g., due to an unsuccessfully received message, errors in decoding, etc.). The base station 105 may receive the NACK feedback for scheduling instance 405-d and may determine to retransmit the information from scheduling instance 405-d to the UE 115 using scheduling instance 405-e. In some cases, the UE 115 may determine to skip on durations 415-e and 415-f (e.g., to conserve power) and may miss scheduling instances 405-e and 405-f. Accordingly, the base station 105 may not receive feedback for scheduling instance 405-e and may determine to retransmit the information from scheduling instance 405-e to the UE 115 using scheduling instance 405-f. Similarly, the base station 105 may not receive feedback for scheduling instance 405-f (e.g., because the UE 115 may skip on duration 415-f) and may determine to retransmit the information from scheduling instance 405-f to the UE 115 using scheduling instance 405-g. The UE 115 may wake up for on duration 415-g, may attempt to receive the retransmission within scheduling instance 405-g, and may transmit corresponding feedback to the base station 105.

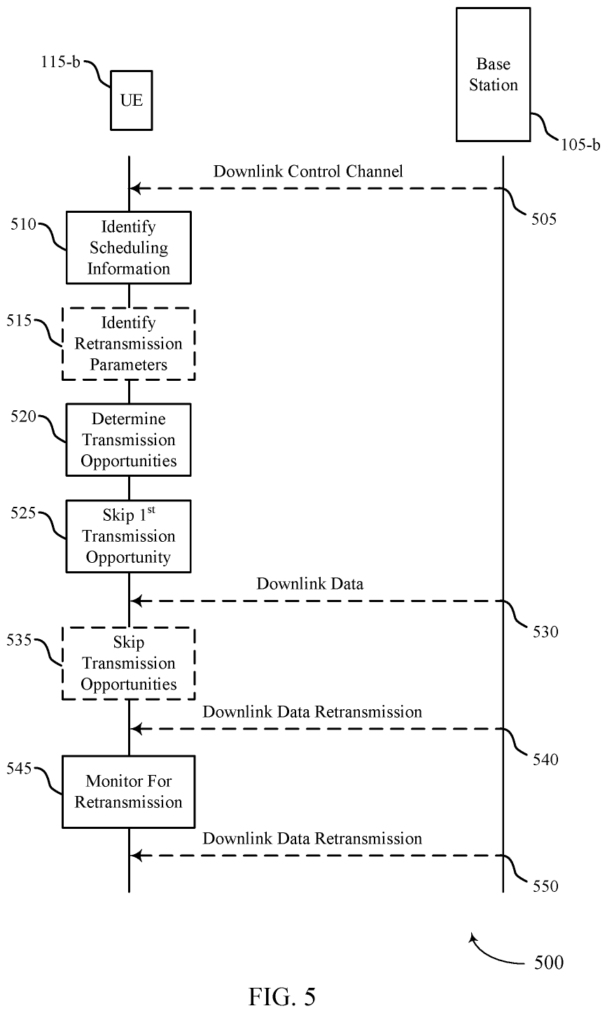

FIG. 5 illustrates an example of a process flow 500 that supports discretionary on duration for wireless devices in accordance with one or more aspects of the present disclosure. In some examples, process flow 500 may implement aspects of wireless communications systems 100 or 200 and may be implemented by a UE 115-b and a base station 105-b, which may be examples of a UE 115 and a base station 105 described with reference to FIGS. 1-4. In some examples, process flow 500 may also implement aspects of one or more of discretionary on configurations 300, 401, or 402.

In the following description of the process flow 500, the operations between UE 115-b and base station 105-b may be transmitted in a different order than the order shown, or the operations performed by base station 105-b and UE 115-b may be performed in different orders or at different times. Some operations may also be left out of the process flow 500, or other operations may be added to the process flow 500. It is to be understood that while base station 105-b and UE 115-b are shown performing a number of the operations of process flow 500, any wireless device may perform the operations shown.

At 505, base station 105-b may, in some cases, transmit, to UE 115-b, a downlink control channel that includes a downlink grant indicating scheduling information for a downlink data transmission for UE 115-b.

At 510, UE 115-b may receive signaling to identify scheduling information for the downlink data transmission from base station 105-b to UE 115-b. In some cases, receiving the signaling to identify the scheduling information may include receiving the downlink control channel that includes the downlink grant indicating scheduling information for the downlink data transmission. In some cases, the retransmission timer associated with downlink retransmissions may correspond to a number of slots (e.g., TTIs) allocated for downlink retransmissions of the downlink data transmission.

At 515, UE 115-b may identify one or more retransmission parameters configured for UE 115-b, where the one or more retransmission parameters may include timing information for an initial downlink data retransmission, a retransmission timer associated with downlink retransmissions, a minimum HARQ response time, or a maximum buffer time. In some cases, UE 115-b may identify a set of higher layer retransmission parameters and a set of lower layer retransmission parameters associated with base station 105-b. In some cases, the set of higher layer retransmission parameters may include RLC parameters and the set of lower layer retransmission parameters include physical layer parameters. In some cases, the set of higher layer retransmission parameters and the set of lower layer retransmission parameters may include one or more poll timers, one or more poll prohibit timers, or any combination thereof.

At 520, UE 115-b may determine a set of transmission opportunities associated with the downlink data transmission within an on duration based on the scheduling information and the one or more retransmission parameters configured for UE 115-b. In some cases, determining the set of transmission opportunities may include identifying an initial transmission opportunity for the downlink data transmission, where the initial transmission opportunity may be indicated by the scheduling information, and determining one or more transmission opportunities associated with retransmission of the downlink data transmission based on the one or more retransmission parameters and timing information of the on duration. In some examples, the timing information of the on duration may include a start time of the on duration, an end time of the on duration, or both. In some examples, the timing information for the initial downlink data retransmission may correspond to a number of symbols between a start of the on duration and a timing of a downlink grant for the initial downlink data retransmission.

At 525, UE 115-b may skip monitoring of one or more first transmission opportunities of the set of transmission opportunities by maintaining a sleep state during the on duration based on the scheduling information and the one or more retransmission parameters configured for UE 115-b. In some cases, the one or more first transmission opportunities may be an initial transmission opportunity within the on duration and may be indicated by the scheduling information.

In some examples, UE 115-b may skip monitoring of the one or more first transmission opportunities of the set of transmission opportunities based on a traffic type or a QoS associated with the downlink data transmission. In some examples, UE 115-b may identify a flag indicator corresponding to the downlink data transmission, where the flag indicator may indicate an estimated arrival rate for the traffic type associated with the downlink data transmission and may skip monitoring of the one or more first transmission opportunities based on the flag indicator or based on the estimated arrival rate for the traffic type. In some examples, UE 115-b may identify a setting for the UE associated with a requested or target power savings, determine a power saving level at UE 115-b based on the setting for the UE, and may skip monitoring of the one or more first transmission opportunities based on the determined power saving level. In some cases, the setting for the UE may be a setting or a preference set by a user of the UE for a requested or target power savings.

In some examples, UE 115-b may skip monitoring of the one or more first transmission opportunities of the set of transmission opportunities based on a current power level of UE 115-b. In some examples, UE 115-b may identify a channel condition of a channel for the downlink data transmission and may skip monitoring of the channel during the one or more first transmission opportunities of the set of transmission opportunities based on the channel condition. In some examples, UE 115-b may skip monitoring of the one or more first transmission opportunities of the set of transmission opportunities based on the set of higher layer retransmission parameters and the set of lower layer retransmission parameters. In some examples, UE 115-b may skip monitoring of the one or more first transmission opportunities of the set of transmission opportunities based on a set of processes to be performed by UE 115-b, where the set of processes may include at least one of a tracking loop update, a mobility update, a beam management procedure, an uplink reporting procedure, or reception of one or more reference signals, or any combination thereof.

At 530, base station 105-b may transmit the downlink data transmission to UE 115-b within the one or more first transmission opportunities.

At 535, UE 115-b may skip monitoring of multiple transmission opportunities of the set of transmission opportunities based on the one or more retransmission parameters, where at least on of one or more second transmission opportunities may be subsequent to each of the multiple transmission opportunities. In some cases, UE 115-b may report an MCS to base station 105-b based on the skipping, where the MCS may correspond to a number of transmission opportunities skipped by UE 115-b.

At 540, base station 105-b may retransmit the downlink data transmission to UE 115-b within multiple transmission opportunities of the set of transmission opportunities.

At 545, UE 115-b may monitor, in in an awake state during the on duration, for a retransmission of the downlink data transmission during the one or more second transmission opportunities after the one or more first transmission opportunities of the set of transmission opportunities. In some cases, the one or more second transmission opportunities may include a last transmission opportunity within the on duration.

At 550, base station 105-b may retransmit the downlink data transmission to UE 115-b within the one or more second transmission opportunities.

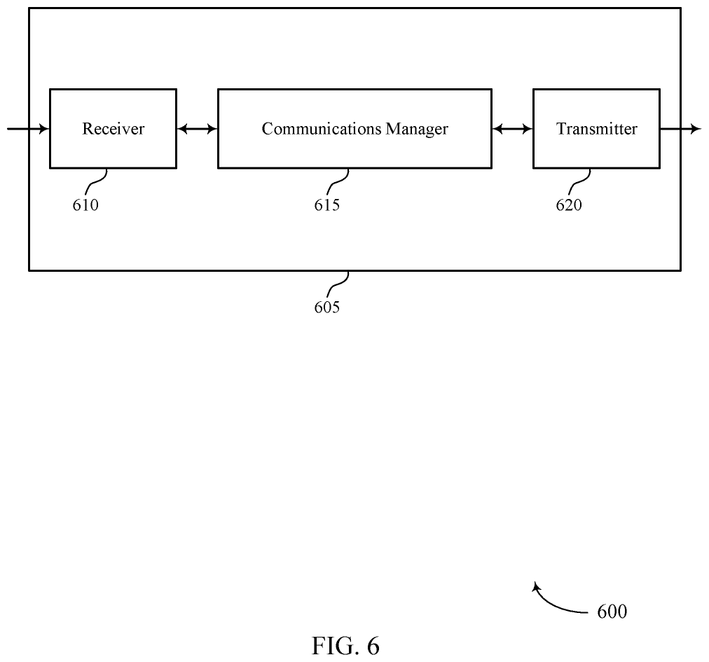

FIG. 6 shows a block diagram 600 of a device 605 that supports discretionary on duration for wireless devices in accordance with one or more aspects of the present disclosure. The device 605 may be an example of aspects of a UE 115 as described herein. The device 605 may include a receiver 610, a communications manager 615, and a transmitter 620. The device 605 may also include a processor. Each of these components may be in communication with one another (e.g., via one or more buses).

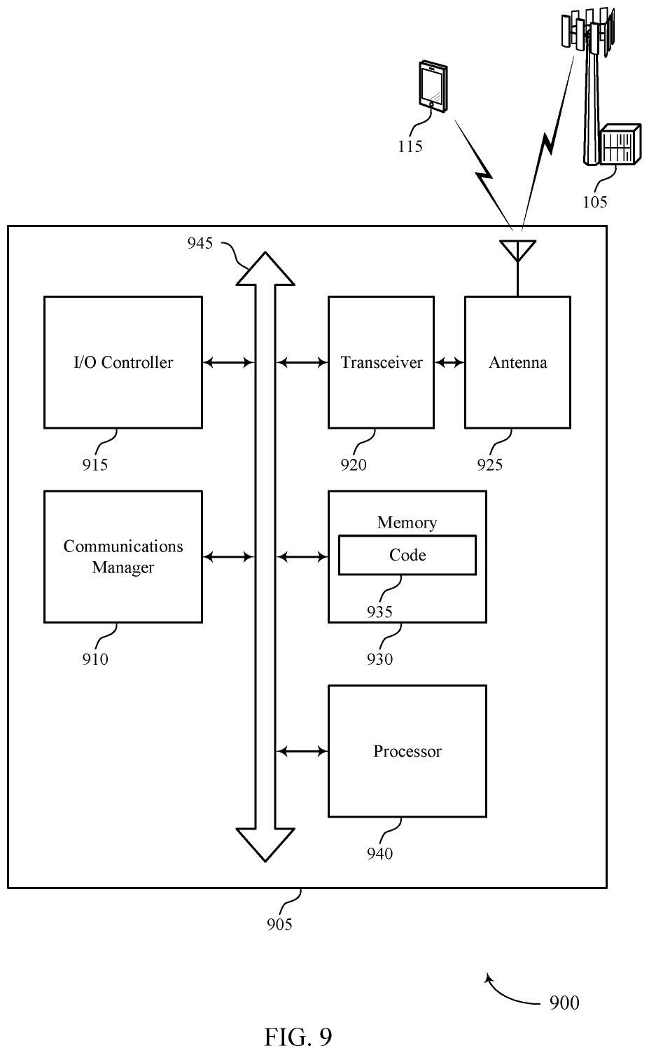

The receiver 610 may receive information such as packets, user data, or control information associated with various information channels (e.g., control channels, data channels, and information related to discretionary on duration for wireless devices, etc.). Information may be passed on to other components of the device 605. The receiver 610 may be an example of aspects of the transceiver 920 described with reference to FIG. 9. The receiver 610 may utilize a single antenna or a set of antennas.

The communications manager 615 may receive signaling to identify, by the UE, scheduling information for a downlink data transmission from a base station to the UE and determine a set of transmission opportunities associated with the downlink data transmission within an on duration based on the scheduling information and one or more retransmission parameters configured for the UE. The UE may further skip monitoring of one or more first transmission opportunities of the set of transmission opportunities by maintaining a sleep state during the on duration based on the scheduling information and the one or more retransmission parameters configured for the UE. The UE may also monitor, by the UE in an awake state during the on duration, for a retransmission of the downlink data transmission during one or more second transmission opportunities after the one or more first transmission opportunities of the set of transmission opportunities. The communications manager 615 may be an example of aspects of the communications manager 910 described herein.

The communications manager 615, or its sub-components, may be implemented in hardware, code (e.g., software or firmware) executed by a processor, or any combination thereof. If implemented in code executed by a processor, the functions of the communications manager 615, or its sub-components may be executed by a general-purpose processor, a digital signal processor (DSP), an application-specific integrated circuit (ASIC), a field-programmable gate array (FPGA) or other programmable logic device, discrete gate or transistor logic, discrete hardware components, or any combination thereof designed to perform the functions described in the present disclosure.

The communications manager 615, or its sub-components, may be physically located at various positions, including being distributed such that portions of functions are implemented at different physical locations by one or more physical components. In some examples, the communications manager 615, or its sub-components, may be a separate and distinct component in accordance with various aspects of the present disclosure. In some examples, the communications manager 615, or its sub-components, may be combined with one or more other hardware components, including but not limited to an input/output (I/O) component, a transceiver, a network server, another computing device, one or more other components described in the present disclosure, or a combination thereof in accordance with various aspects of the present disclosure.

The actions performed by the communications manager 615 as described herein may be implemented to realize one or more potential advantages. For example, communications manager 615 may increase power savings at the UE 115 by providing additional sleep time for the UE 115 during a discontinuous mode. Communications manager 615 may determine to provide such additional sleep time in cases where power savings are desired (e.g., when battery is low, in a limited coverage area, etc.), thus providing enhanced communication ability at the UE 115.

The transmitter 620 may transmit signals generated by other components of the device 605. In some examples, the transmitter 620 may be collocated with a receiver 610 in a transceiver module. For example, the transmitter 620 may be an example of aspects of the transceiver 920 described with reference to FIG. 9. The transmitter 620 may utilize a single antenna or a set of antennas.

In some examples, the communications manager 615 may be implemented as an integrated circuit or chipset for a mobile device modem, and the receiver 610 and transmitter 620 may be implemented as analog components (e.g., amplifiers, filters, antennas, etc.) coupled with the mobile device modem to enable wireless transmission and reception over one or more bands.

In one or more aspects, the described techniques performed by the communications manager 615 as described herein may support improvements in on duration operations at a UE. For example, communications manager 615 may increase available power at a wireless device (e.g., a UE 115) by supporting implementation of a discretionary on duration during a DRX cycle. The discretionary on duration may reduce power consumption at a device compared to other systems and techniques, for example, that do not support a discretionary on duration during a DRX cycle. Accordingly, communications manager 515 may save power and increase battery life at a wireless device (e.g., a UE 115) by strategically reducing an amount of on duration time during a DRX cycle (e.g., when a UE 115 is configured by a base station to operate in a DRX mode).

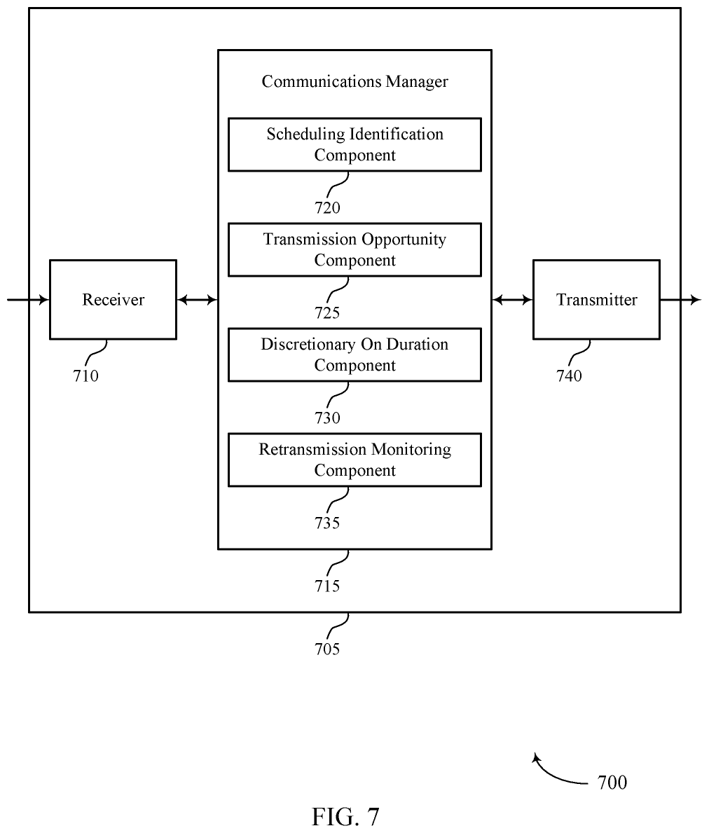

FIG. 7 shows a block diagram 700 of a device 705 that supports discretionary on duration for wireless devices in accordance with one or more aspects of the present disclosure. The device 705 may be an example of aspects of a device 605, or a UE 115 as described herein. The device 705 may include a receiver 710, a communications manager 715, and a transmitter 740. The device 705 may also include a processor. Each of these components may be in communication with one another (e.g., via one or more buses).

The receiver 710 may receive information such as packets, user data, or control information associated with various information channels (e.g., control channels, data channels, and information related to discretionary on duration for wireless devices, etc.). Information may be passed on to other components of the device 705. The receiver 710 may be an example of aspects of the transceiver 920 described with reference to FIG. 9. The receiver 710 may utilize a single antenna or a set of antennas.

The communications manager 715 may be an example of aspects of the communications manager 615 as described herein. The communications manager 715 may include a scheduling identification component 720, a transmission opportunity component 725, a discretionary on duration component 730, and a retransmission monitoring component 735. The communications manager 715 may be an example of aspects of the communications manager 910 described herein.

The scheduling identification component 720 may receive signaling to identify, by the UE, scheduling information for a downlink data transmission from a base station to the UE. The transmission opportunity component 725 may determine a set of transmission opportunities associated with the downlink data transmission within an on duration based on the scheduling information and one or more retransmission parameters configured for the UE.

The discretionary on duration component 730 may skip monitoring of one or more first transmission opportunities of the set of transmission opportunities by maintaining a sleep state during the on duration based on the scheduling information and the one or more retransmission parameters configured for the UE. The retransmission monitoring component 735 may monitor, by the UE in an awake state during the on duration, for a retransmission of the downlink data transmission during one or more second transmission opportunities after the one or more first transmission opportunities of the set of transmission opportunities.

The transmitter 740 may transmit signals generated by other components of the device 705. In some examples, the transmitter 740 may be collocated with a receiver 710 in a transceiver module. For example, the transmitter 740 may be an example of aspects of the transceiver 920 described with reference to FIG. 9. The transmitter 740 may utilize a single antenna or a set of antennas.

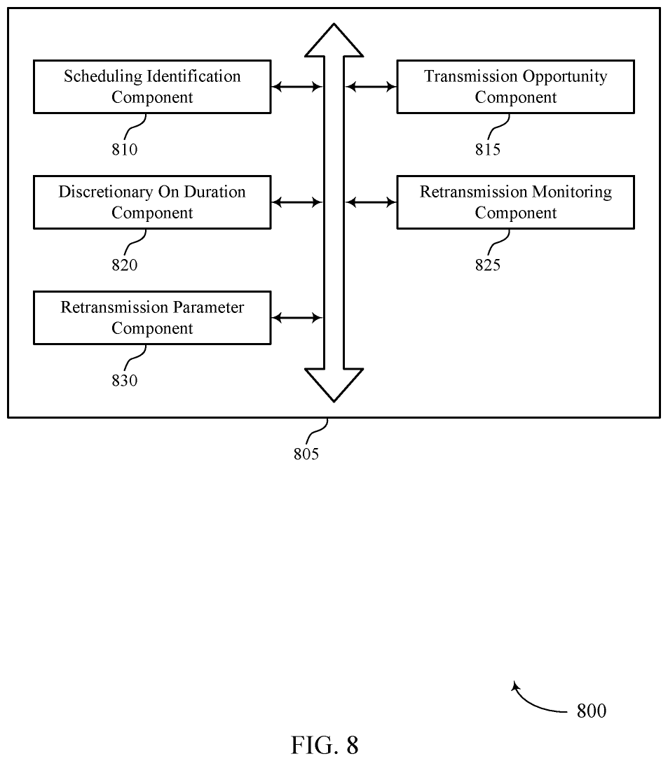

A processor of a wireless device (e.g., controlling the receiver 710, the transmitter 740, or the transceiver 920 as described with reference to FIG. 9) may increase available power at a wireless device by supporting implementation of a discretionary on duration during a DRX cycle. The discretionary on duration may reduce power consumption (e.g., via implementation of system components described with reference to FIG. 8) compared to other systems and techniques, for example, that do not support a discretionary on duration during a DRX cycle. Further, the processor of the UE 115 may identify one or more aspects of discretionary on duration configuration to perform the techniques described herein. The processor of the wireless device may use the discretionary on duration configuration to perform one or more actions that may result in lower power consumption, save power, and increase battery life at the wireless device (e.g., by communicating according to a discretionary on duration configuration during a configured DRX cycle), among other improvements.

FIG. 8 shows a block diagram 800 of a communications manager 805 that supports discretionary on duration for wireless devices in accordance with one or more aspects of the present disclosure. The communications manager 805 may be an example of aspects of a communications manager 615, a communications manager 715, or a communications manager 910 described herein. The communications manager 805 may include a scheduling identification component 810, a transmission opportunity component 815, a discretionary on duration component 820, a retransmission monitoring component 825, and a retransmission parameter component 830. Each of these modules may communicate, directly or indirectly, with one another (e.g., via one or more buses).

The scheduling identification component 810 may receive signaling to identify, by the UE, scheduling information for a downlink data transmission from a base station to the UE. In some examples, receiving the signaling to identify the scheduling information may include receiving a downlink control channel that includes a downlink grant indicating the scheduling information for the downlink data transmission for the UE.

The transmission opportunity component 815 may determine a set of transmission opportunities associated with the downlink data transmission within an on duration based on the scheduling information and one or more retransmission parameters configured for the UE. In some examples, the transmission opportunity component 815 may identify an initial transmission opportunity for the downlink data transmission, where the initial transmission opportunity is indicated by the scheduling information. In some examples, the transmission opportunity component 815 may determine one or more transmission opportunities associated with retransmission of the downlink data transmission based on the one or more retransmission parameters and timing information of the on duration. In some cases, the timing information of the on duration includes a start time of the on duration, an end time of the on duration, or both. In some cases, the one or more first transmission opportunities include an initial transmission opportunity within the on duration and indicated by the scheduling information. In some cases, one or more second transmission opportunities include a last transmission opportunity within the on duration.

The discretionary on duration component 820 may skip monitoring of one or more first transmission opportunities of the set of transmission opportunities by maintaining a sleep state during the on duration based on the scheduling information and the one or more retransmission parameters configured for the UE. In some examples, the discretionary on duration component 820 may skip monitoring of multiple transmission opportunities of the set of transmission opportunities based on the one or more retransmission parameters, where at least one of the one or more second transmission opportunities is subsequent to each of the multiple transmission opportunities. In some examples, the discretionary on duration component 820 may skip monitoring of the one or more first transmission opportunities of the set of transmission opportunities based on a traffic type or a quality of service associated with the downlink data transmission.

In some examples, the discretionary on duration component 820 may identify a flag indicator corresponding to the downlink data transmission, where the flag indicator indicates an estimated arrival rate for the traffic type associated with the downlink data transmission. In some examples, the discretionary on duration component 820 may skip monitoring of the one or more first transmission opportunities based on the flag indicator or based on the estimated arrival rate for the traffic type. In some examples, the discretionary on duration component 820 may identify a setting for the UE associated with a requested or target power savings and determine a power saving level at the UE based on the setting for the UE. In some examples, the discretionary on duration component 820 may skip monitoring of the one or more first transmission opportunities based on the determined power saving level. In some examples, the discretionary on duration component 820 may skip monitoring of the one or more first transmission opportunities of the set of transmission opportunities based on a current battery power level of the UE.

In some examples, the discretionary on duration component 820 may identify a channel condition of a channel for the downlink data transmission. In some examples, the discretionary on duration component 820 may skip monitoring of the channel during the one or more first transmission opportunities of the set of transmission opportunities based on the channel condition. In some examples, the discretionary on duration component 820 may report an MCS to the base station based on the skipping, where the MCS corresponds to a number of transmission opportunities skipped by the UE. In some examples, the discretionary on duration component 820 may skip monitoring of the one or more first transmission opportunities of the set of transmission opportunities based on the set of higher layer retransmission parameters and the set of lower layer retransmission parameters. In some examples, skipping monitoring of the one or more first transmission opportunities of the set of transmission opportunities may be based on a set of processes to be performed by the UE, where the set of processes includes at least one of a tracking loop update, a mobility update, a beam management procedure, an uplink reporting procedure, or reception of one or more reference signals, or any combination thereof.

The retransmission monitoring component 825 may monitor, by the UE in an awake state during the on duration, for a retransmission of the downlink data transmission during the one or more second transmission opportunities after the one or more first transmission opportunities of the set of transmission opportunities.

The retransmission parameter component 830 may identify the one or more retransmission parameters configured for the UE, where the one or more retransmission parameters includes timing information for an initial downlink data retransmission, a retransmission timer associated with downlink retransmissions, a minimum HARQ response time, or a maximum buffer time. In some examples, the retransmission parameter component 830 may identify a set of higher layer retransmission parameters and a set of lower layer retransmission parameters associated with the base station. In some cases, the timing information for the initial downlink data retransmission corresponds to a number of symbols between a start of the on duration and a timing of a downlink grant for the initial downlink data retransmission.

In some cases, the retransmission timer associated with downlink retransmissions corresponds to a number of slots allocated for downlink retransmissions of the downlink data transmission. In some cases, the set of higher layer retransmission parameters includes RLC parameters and the set of lower layer retransmission parameters includes physical layer parameters. In some cases, the set of higher layer retransmission parameters and the set of lower layer retransmission parameters include one or more poll timers, one or more poll prohibit timers, or any combination thereof.

FIG. 9 shows a diagram of a system 900 including a device 905 that supports discretionary on duration for wireless devices in accordance with one or more aspects of the present disclosure. The device 905 may be an example of or include the components of device 605, device 705, or a UE 115 as described herein. The device 905 may include components for bi-directional voice and data communications including components for transmitting and receiving communications, including a communications manager 910, an I/O controller 915, a transceiver 920, an antenna 925, memory 930, and a processor 940. These components may be in electronic communication via one or more buses (e.g., bus 945).

The communications manager 910 may receive signaling to identify, by the UE, scheduling information for a downlink data transmission from a base station to the UE and determine a set of transmission opportunities associated with the downlink data transmission within an on duration based on the scheduling information and one or more retransmission parameters configured for the UE. The communications manager 910 may skip monitoring of one or more first transmission opportunities of the set of transmission opportunities by maintaining a sleep state during the on duration based on the scheduling information and the one or more retransmission parameters configured for the UE. The communications manager 910 may also monitor, by the UE in an awake state during the on duration, for a retransmission of the downlink data transmission during one or more second transmission opportunities after the one or more first transmission opportunities of the set of transmission opportunities.

The I/O controller 915 may manage input and output signals for the device 905. The I/O controller 915 may also manage peripherals not integrated into the device 905. In some cases, the I/O controller 915 may represent a physical connection or port to an external peripheral. In some cases, the I/O controller 915 may utilize an operating system such as iOS®, ANDROID®, MS-DOS®, MS-WINDOWS®, OS/2®, UNIX®, LINUX®, or another known operating system. In other cases, the I/O controller 915 may represent or interact with a modem, a keyboard, a mouse, a touchscreen, or a similar device. In some cases, the I/O controller 915 may be implemented as part of a processor. In some cases, a user may interact with the device 905 via the I/O controller 915 or via hardware components controlled by the I/O controller 915.

The transceiver 920 may communicate bi-directionally, via one or more antennas, wired, or wireless links as described above. For example, the transceiver 920 may represent a wireless transceiver and may communicate bi-directionally with another wireless transceiver. The transceiver 920 may also include a modem to modulate the packets and provide the modulated packets to the antennas for transmission, and to demodulate packets received from the antennas.

In some cases, the device 905 may include a single antenna 925, or the device 905 may have more than one antenna 925, which may be capable of concurrently transmitting or receiving multiple wireless transmissions.

The memory 930 may include random access memory (RAM) and read-only memory (ROM). The memory 930 may store computer-readable, computer-executable code 935 including instructions that, when executed, cause the processor to perform various functions described herein. In some cases, the memory 930 may contain, among other things, a basic I/O system (BIOS) which may control basic hardware or software operation such as the interaction with peripheral components or devices.

The processor 940 may include an intelligent hardware device, (e.g., a general-purpose processor, a DSP, a CPU, a microcontroller, an ASIC, an FPGA, a programmable logic device, a discrete gate or transistor logic component, a discrete hardware component, or any combination thereof). In some cases, the processor 940 may be configured to operate a memory array using a memory controller. In other cases, a memory controller may be integrated into the processor 940. The processor 940 may be configured to execute computer-readable instructions stored in a memory (e.g., the memory 930) to cause the device 905 to perform various functions (e.g., functions or tasks supporting discretionary on duration for wireless devices).

The processor 940 of a UE 115 may enable one or more additional sleep modes in cases where power savings are desired (e.g., when battery is low, in a limited coverage area, etc.), thus providing enhanced communication ability at the UE 115. The processor may perform less functions during the sleep mode (e.g., may not enable monitoring for communications, etc.) and may thus conserve power at the processor and at other components of the UE 115. In some cases, power conservation may increase the battery life and communication timespan at the UE 115, allowing the UE 115 to communicate for longer periods of time in some situations.

The code 935 may include instructions to implement aspects of the present disclosure, including instructions to support wireless communications. The code 935 may be stored in a non-transitory computer-readable medium such as system memory or other type of memory. In some cases, the code 935 may not be directly executable by the processor 940 but may cause a computer (e.g., when compiled and executed) to perform functions described herein.

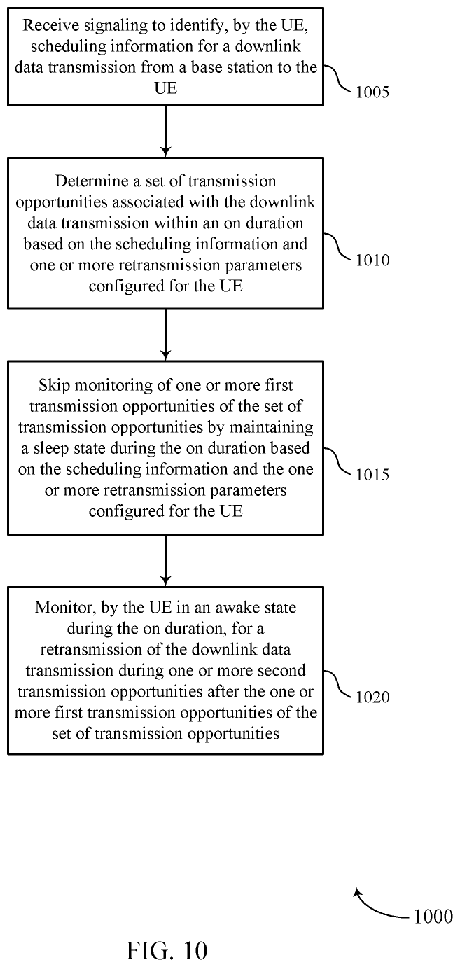

FIG. 10 shows a flowchart illustrating a method 1000 that supports discretionary on duration for wireless devices in accordance with one or more aspects of the present disclosure. The operations of method 1000 may be implemented by a UE 115 or its components as described herein. For example, the operations of method 1000 may be performed by a communications manager as described with reference to FIGS. 6 through 9. In some examples, a UE may execute a set of instructions to control the functional elements of the UE to perform the functions described below. Additionally or alternatively, a UE may perform aspects of the functions described below using special-purpose hardware.

At 1005, the UE may receive signaling to identify, by the UE, scheduling information for a downlink data transmission from a base station to the UE. The operations of 1005 may be performed according to the methods described herein. In some examples, aspects of the operations of 1005 may be performed by a scheduling identification component as described with reference to FIGS. 6 through 9.

At 1010, the UE may determine a set of transmission opportunities associated with the downlink data transmission within an on duration based on the scheduling information and one or more retransmission parameters configured for the UE. The operations of 1010 may be performed according to the methods described herein. In some examples, aspects of the operations of 1010 may be performed by a transmission opportunity component as described with reference to FIGS. 6 through 9.

At 1015, the UE may skip monitoring of one or more first transmission opportunities of the set of transmission opportunities by maintaining a sleep state during the on duration based on the scheduling information and the one or more retransmission parameters configured for the UE. The operations of 1015 may be performed according to the methods described herein. In some examples, aspects of the operations of 1015 may be performed by a discretionary on duration component as described with reference to FIGS. 6 through 9.

At 1020, the UE may monitor, by the UE in an awake state during the on duration, for a retransmission of the downlink data transmission during one or more second transmission opportunities after the one or more first transmission opportunities of the set of transmission opportunities. The operations of 1020 may be performed according to the methods described herein. In some examples, aspects of the operations of 1020 may be performed by a retransmission monitoring component as described with reference to FIGS. 6 through 9.

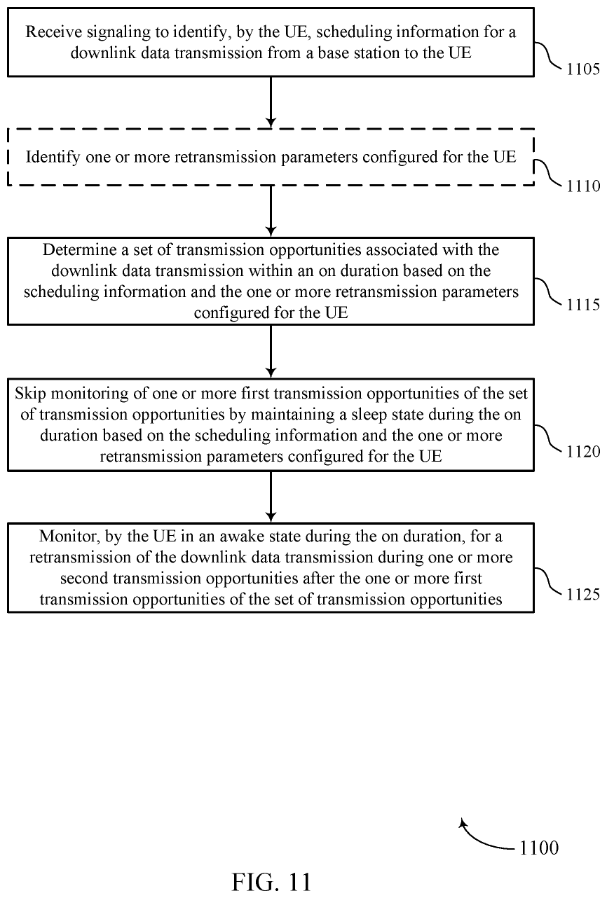

FIG. 11 shows a flowchart illustrating a method 1100 that supports discretionary on duration for wireless devices in accordance with one or more aspects of the present disclosure. The operations of method 1100 may be implemented by a UE 115 or its components as described herein. For example, the operations of method 1100 may be performed by a communications manager as described with reference to FIGS. 6 through 9. In some examples, a UE may execute a set of instructions to control the functional elements of the UE to perform the functions described below. Additionally or alternatively, a UE may perform aspects of the functions described below using special-purpose hardware.

At 1105, the UE may receive signaling to identify, by the UE, scheduling information for a downlink data transmission from a base station to the UE. The operations of 1105 may be performed according to the methods described herein. In some examples, aspects of the operations of 1105 may be performed by a scheduling identification component as described with reference to FIGS. 6 through 9.

At 1110, the UE may identify the one or more retransmission parameters configured for the UE, where the one or more retransmission parameters includes timing information for an initial downlink data retransmission, a retransmission timer associated with downlink retransmissions, a minimum HARQ response time, or a maximum buffer time. The operations of 1110 may be performed according to the methods described herein. In some examples, aspects of the operations of 1110 may be performed by a retransmission parameter component as described with reference to FIGS. 6 through 9.

At 1115, the UE may determine a set of transmission opportunities associated with the downlink data transmission within an on duration based on the scheduling information and one or more retransmission parameters configured for the UE. The operations of 1115 may be performed according to the methods described herein. In some examples, aspects of the operations of 1115 may be performed by a transmission opportunity component as described with reference to FIGS. 6 through 9.

At 1120, the UE may skip monitoring of one or more first transmission opportunities of the set of transmission opportunities by maintaining a sleep state during the on duration based on the scheduling information and the one or more retransmission parameters configured for the UE. The operations of 1120 may be performed according to the methods described herein. In some examples, aspects of the operations of 1120 may be performed by a discretionary on duration component as described with reference to FIGS. 6 through 9.

At 1125, the UE may monitor, by the UE in an awake state during the on duration, for a retransmission of the downlink data transmission during one or more second transmission opportunities after the one or more first transmission opportunities of the set of transmission opportunities. The operations of 1125 may be performed according to the methods described herein. In some examples, aspects of the operations of 1125 may be performed by a retransmission monitoring component as described with reference to FIGS. 6 through 9.

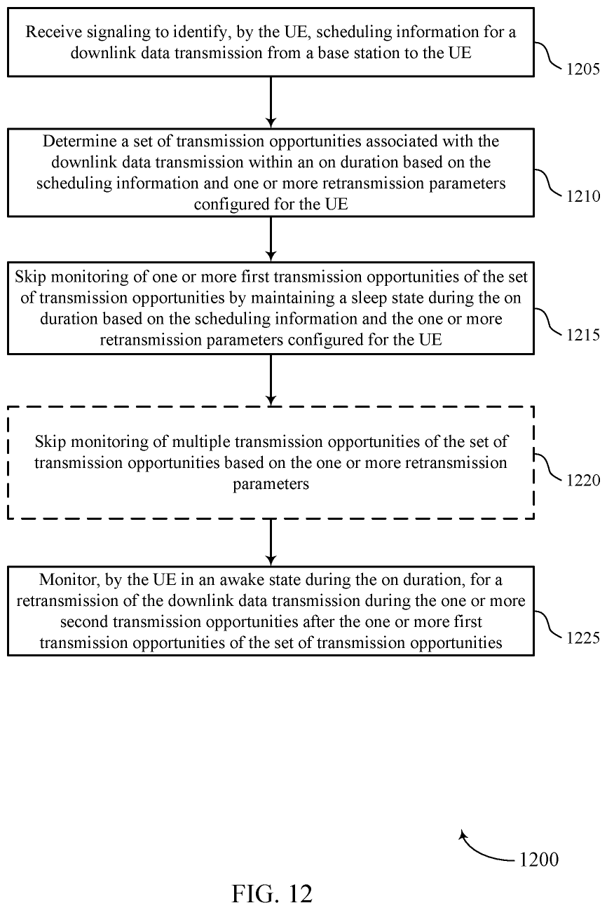

FIG. 12 shows a flowchart illustrating a method 1200 that supports discretionary on duration for wireless devices in accordance with one or more aspects of the present disclosure. The operations of method 1200 may be implemented by a UE 115 or its components as described herein. For example, the operations of method 1200 may be performed by a communications manager as described with reference to FIGS. 6 through 9. In some examples, a UE may execute a set of instructions to control the functional elements of the UE to perform the functions described below. Additionally or alternatively, a UE may perform aspects of the functions described below using special-purpose hardware.

At 1205, the UE may receive signaling to identify, by the UE, scheduling information for a downlink data transmission from a base station to the UE. The operations of 1205 may be performed according to the methods described herein. In some examples, aspects of the operations of 1205 may be performed by a scheduling identification component as described with reference to FIGS. 6 through 9.

At 1210, the UE may determine a set of transmission opportunities associated with the downlink data transmission within an on duration based on the scheduling information and one or more retransmission parameters configured for the UE. The operations of 1210 may be performed according to the methods described herein. In some examples, aspects of the operations of 1210 may be performed by a transmission opportunity component as described with reference to FIGS. 6 through 9.

At 1215, the UE may skip monitoring of one or more first transmission opportunities of the set of transmission opportunities by maintaining a sleep state during the on duration based on the scheduling information and the one or more retransmission parameters configured for the UE. The operations of 1215 may be performed according to the methods described herein. In some examples, aspects of the operations of 1215 may be performed by a discretionary on duration component as described with reference to FIGS. 6 through 9.

At 1220, the UE may skip monitoring of multiple transmission opportunities of the set of transmission opportunities based on the one or more retransmission parameters, where at least one of the one or more second transmission opportunities is subsequent to each of the multiple transmission opportunities. The operations of 1220 may be performed according to the methods described herein. In some examples, aspects of the operations of 1220 may be performed by a discretionary on duration component as described with reference to FIGS. 6 through 9.

At 1225, the UE may monitor, by the UE in an awake state during the on duration, for a retransmission of the downlink data transmission during one or more second transmission opportunities after the one or more first transmission opportunities of the set of transmission opportunities. The operations of 1225 may be performed according to the methods described herein. In some examples, aspects of the operations of 1225 may be performed by a retransmission monitoring component as described with reference to FIGS. 6 through 9.

It should be noted that the methods described herein describe possible implementations, and that the operations and the steps may be rearranged or otherwise modified and that other implementations are possible. Further, aspects from two or more of the methods may be combined.

The following provides an overview of examples of the present disclosure:

Example 1: A method for wireless communication at a UE, comprising: receiving signaling to identify, by the UE, scheduling information for a downlink data transmission from a base station to the UE; determining a plurality of transmission opportunities associated with the downlink data transmission within an on duration based at least in part on the scheduling information and one or more retransmission parameters configured for the UE; skipping monitoring of one or more first transmission opportunities of the plurality of transmission opportunities by maintaining a sleep state during the on duration based at least in part on the scheduling information and the one or more retransmission parameters configured for the UE; and monitoring, by the UE in an awake state during the on duration, for a retransmission of the downlink data transmission during one or more second transmission opportunities after the one or more first transmission opportunities of the plurality of transmission opportunities.

Example 2: The method of example 1, further comprising: identifying the one or more retransmission parameters configured for the UE, wherein the one or more retransmission parameters comprises timing information for an initial downlink data retransmission, a retransmission timer associated with downlink retransmissions, a minimum hybrid automatic repeat request (HARQ) response time, or a maximum buffer time.

Example 3: The method of example 2, wherein determining the plurality of transmission opportunities comprises: identifying an initial transmission opportunity for the downlink data transmission, wherein the initial transmission opportunity is indicated by the scheduling information; and determining one or more transmission opportunities associated with retransmission of the downlink data transmission based at least in part on the one or more retransmission parameters and timing information of the on duration.

Example 4: The method of example 3, wherein the timing information of the on duration comprises a start time of the on duration, an end time of the on duration, or both.

Example 5: The method of any of examples 2 through 4, wherein the timing information for the initial downlink data retransmission corresponds to a number of symbols between a start of the on duration and a timing of a downlink grant for the initial downlink data retransmission.

Example 6: The method of any of examples 2 through 5, wherein the retransmission timer associated with downlink retransmissions corresponds to a number of slots allocated for downlink retransmissions of the downlink data transmission.

Example 7: The method of any of examples 1 through 6, further comprising: skipping monitoring of multiple transmission opportunities of the plurality of transmission opportunities based at least in part on the one or more retransmission parameters, wherein at least one of the one or more second transmission opportunities is subsequent to each of the multiple transmission opportunities.

Example 8: The method of example 7, wherein: the one or more first transmission opportunities comprise an initial transmission opportunity within the on duration and indicated by the scheduling information; and the one or more second transmission opportunities comprise a last transmission opportunity within the on duration.

Example 9: The method of any of examples 1 through 8, further comprising: skipping monitoring of the one or more first transmission opportunities of the plurality of transmission opportunities based at least in part on a traffic type or a quality of service associated with the downlink data transmission.

Example 10: The method of example 9, further comprising: identifying a flag indicator corresponding to the downlink data transmission, wherein the flag indicator indicates an estimated arrival rate for the traffic type associated with the downlink data transmission; and skipping monitoring of the one or more first transmission opportunities based at least in part on the estimated arrival rate for the traffic type.

Example 11: The method of example 10, further comprising: identifying a setting for the UE associated with a requested or target power savings, determining a power saving level at the UE based at least in part on the setting for the UE; and skipping monitoring of the one or more first transmission opportunities based at least in part on the determined power saving level.

Example 12: The method of any of examples 1 through 11, further comprising: skipping monitoring of the one or more first transmission opportunities of the plurality of transmission opportunities based at least in part on a current battery power level of the UE.

Example 13: The method of any of examples 1 through 12, further comprising: identifying a channel condition of a channel for the downlink data transmission; and skipping monitoring of the channel during the one or more first transmission opportunities of the plurality of transmission opportunities based at least in part on the channel condition.

Example 14: The method of any of examples 1 through 13, further comprising: reporting an MCS to the base station based at least in part on the skipping, wherein the modulation and coding scheme corresponds to a number of transmission opportunities skipped by the UE.

Example 15: The method of any of examples 1 through 14, further comprising: identifying a set of higher layer retransmission parameters and a set of lower layer retransmission parameters associated with the base station; and skipping monitoring of the one or more first transmission opportunities of the plurality of transmission opportunities based at least in part on the set of higher layer retransmission parameters and the set of lower layer retransmission parameters.

Example 16: The method of example 15, wherein the set of higher layer retransmission parameters comprises RLC parameters and the set of lower layer retransmission parameters comprises physical layer parameters.

Example 17: The method of any of examples of 15 or 16, wherein the set of higher layer retransmission parameters and the set of lower layer retransmission parameters comprise one or more poll timers, one or more poll prohibit timers, or any combination thereof.

Example 18: The method of any of examples 1 through 17, further comprising: skipping monitoring of the one or more first transmission opportunities of the plurality of transmission opportunities based at least in part on a set of processes to be performed by the UE, wherein the set of processes comprises at least one of a tracking loop update, a mobility update, a beam management procedure, an uplink reporting procedure, or reception of one or more reference signals, or any combination thereof.

Example 19: The method of any of examples 1 through 18, wherein receiving the signaling to identify the scheduling information comprises: receiving a downlink control channel that comprises a downlink grant indicating the scheduling information for the downlink data transmission for the UE.

Example 20: An apparatus for wireless communication comprising at least one means for performing a method of any one of examples 1 through 19.

Example 21: An apparatus for wireless communication comprising a processor and memory coupled to the processor. The processor and memory configured to perform a method of any one of examples 1 through 19.

Example 22: A non-transitory computer-readable medium storing code for wireless communication comprising a processor, memory coupled with the processor, and instructions stored in the memory and executable by the processor to cause the apparatus to perform a method of any one of examples 1 through 22.

Although aspects of an LTE, LTE-A, LTE-A Pro, or NR system may be described for purposes of example, and LTE, LTE-A, LTE-A Pro, or NR terminology may be used in much of the description, the techniques described herein are applicable beyond LTE, LTE-A, LTE-A Pro, or NR networks. For example, the described techniques may be applicable to various other wireless communications systems such as Ultra Mobile Broadband (UMB), Institute of Electrical and Electronics Engineers (IEEE) 802.11 (Wi-Fi), IEEE 802.16 (WiMAX), IEEE 802.20, Flash-OFDM, as well as other systems and radio technologies not explicitly mentioned herein.

Information and signals described herein may be represented using any of a variety of different technologies and techniques. For example, data, instructions, commands, information, signals, bits, symbols, and chips that may be referenced throughout the description may be represented by voltages, currents, electromagnetic waves, magnetic fields or particles, optical fields or particles, or any combination thereof.

The various illustrative blocks and modules described in connection with the disclosure herein may be implemented or performed with a general-purpose processor, a DSP, an ASIC, a CPU, an FPGA or other programmable logic device, discrete gate or transistor logic, discrete hardware components, or any combination thereof designed to perform the functions described herein. A general-purpose processor may be a microprocessor, but in the alternative, the processor may be any processor, controller, microcontroller, or state machine. A processor may also be implemented as a combination of computing devices (e.g., a combination of a DSP and a microprocessor, multiple microprocessors, one or more microprocessors in conjunction with a DSP core, or any other such configuration).

The functions described herein may be implemented in hardware, software executed by a processor, firmware, or any combination thereof. If implemented in software executed by a processor, the functions may be stored on or transmitted over as one or more instructions or code on a computer-readable medium. Other examples and implementations are within the scope of the disclosure and appended claims. For example, due to the nature of software, functions described herein may be implemented using software executed by a processor, hardware, firmware, hardwiring, or combinations of any of these. Features implementing functions may also be physically located at various positions, including being distributed such that portions of functions are implemented at different physical locations.

Computer-readable media includes both non-transitory computer storage media and communication media including any medium that facilitates transfer of a computer program from one place to another. A non-transitory storage medium may be any available medium that may be accessed by a general-purpose or special purpose computer. By way of example, and not limitation, non-transitory computer-readable media may include RAM, ROM, electrically erasable programmable ROM (EEPROM), flash memory, compact disk (CD) ROM or other optical disk storage, magnetic disk storage or other magnetic storage devices, or any other non-transitory medium that may be used to carry or store desired program code means in the form of instructions or data structures and that may be accessed by a general-purpose or special-purpose computer, or a general-purpose or special-purpose processor. Also, any connection is properly termed a computer-readable medium. For example, if the software is transmitted from a website, server, or other remote source using a coaxial cable, fiber optic cable, twisted pair, digital subscriber line (DSL), or wireless technologies such as infrared, radio, and microwave, then the coaxial cable, fiber optic cable, twisted pair, DSL, or wireless technologies such as infrared, radio, and microwave are included in the definition of computer-readable medium. Disk and disc, as used herein, include CD, laser disc, optical disc, digital versatile disc (DVD), floppy disk and Blu-ray disc where disks usually reproduce data magnetically, while discs reproduce data optically with lasers. Combinations of the above are also included within the scope of computer-readable media.

As used herein, including in the claims, “or” as used in a list of items (e.g., a list of items prefaced by a phrase such as “at least one of” or “one or more of”) indicates an inclusive list such that, for example, a list of at least one of A, B, or C means A or B or C or AB or AC or BC or ABC (i.e., A and B and C). Also, as used herein, the phrase “based on” shall not be construed as a reference to a closed set of conditions. For example, an example step that is described as “based on condition A” may be based on both a condition A and a condition B without departing from the scope of the present disclosure. In other words, as used herein, the phrase “based on” shall be construed in the same manner as the phrase “based at least in part on.”

In the appended figures, similar components or features may have the same reference label. Further, various components of the same type may be distinguished by following the reference label by a dash and a second label that distinguishes among the similar components. If just the first reference label is used in the specification, the description is applicable to any one of the similar components having the same first reference label irrespective of the second reference label, or other subsequent reference label.

The description set forth herein, in connection with the appended drawings, describes example configurations and does not represent all the examples that may be implemented or that are within the scope of the claims. The term “example” used herein means “serving as an example, instance, or illustration,” and not “preferred” or “advantageous over other examples.” The detailed description includes specific details for the purpose of providing an understanding of the described techniques. These techniques, however, may be practiced without these specific details. In some instances, well-known structures and devices are shown in block diagram form in order to avoid obscuring the concepts of the described examples.

The description herein is provided to enable a person skilled in the art to make or use the disclosure. Various modifications to the disclosure will be readily apparent to those skilled in the art, and the generic principles defined herein may be applied to other variations without departing from the scope of the disclosure. Thus, the disclosure is not limited to the examples and designs described herein, but is to be accorded the broadest scope consistent with the principles and novel features disclosed herein.

What is claimed is:

1. A method for wireless communications at a user equipment (UE), comprising:
receiving signaling to identify, by the UE, scheduling information for a downlink data transmission from a base station to the UE;
determining a plurality of transmission opportunities associated with the downlink data transmission within an on duration based at least in part on the scheduling information and one or more retransmission parameters configured for the UE;
skipping monitoring of one or more first transmission opportunities of the plurality of transmission opportunities by maintaining a sleep state during the on duration based at least in part on the scheduling information and the one or more retransmission parameters configured for the UE; and
monitoring, by the UE in an awake state during the on duration, for a retransmission of the downlink data transmission during one or more second transmission opportunities after the one or more first transmission opportunities of the plurality of transmission opportunities.

2. The method of claim 1, further comprising:
identifying the one or more retransmission parameters configured for the UE, wherein the one or more retransmission parameters comprises timing information for an initial downlink data retransmission, a retransmission timer associated with downlink retransmissions, a minimum hybrid automatic repeat request (HARQ) response time, or a maximum buffer time.

3. The method of claim 2, wherein determining the plurality of transmission opportunities comprises:
identifying an initial transmission opportunity for the downlink data transmission, wherein the initial transmission opportunity is indicated by the scheduling information; and
determining one or more transmission opportunities associated with retransmission of the downlink data transmission based at least in part on the one or more retransmission parameters and timing information of the on duration.

4. The method of claim 3, wherein the timing information of the on duration comprises a start time of the on duration, an end time of the on duration, or both.

5. The method of claim 2, wherein the timing information for the initial downlink data retransmission corresponds to a number of symbols between a start of the on duration and a timing of a downlink grant for the initial downlink data retransmission.

6. The method of claim 2, wherein the retransmission timer associated with downlink retransmissions corresponds to a number of slots allocated for downlink retransmissions of the downlink data transmission.

7. The method of claim 1, further comprising:
skipping monitoring of multiple transmission opportunities of the plurality of transmission opportunities based at least in part on the one or more retransmission parameters, wherein at least one of the one or more second transmission opportunities is subsequent to each of the multiple transmission opportunities.

8. The method of claim 7, wherein:
the one or more first transmission opportunities comprise an initial transmission opportunity within the on duration and indicated by the scheduling information; and
the one or more second transmission opportunities comprise a last transmission opportunity within the on duration.

9. The method of claim 1, further comprising:
skipping monitoring of the one or more first transmission opportunities of the plurality of transmission opportunities based at least in part on a traffic type or a quality of service associated with the downlink data transmission.

10. The method of claim 9, further comprising:
identifying a flag indicator corresponding to the downlink data transmission, wherein the flag indicator indicates an estimated arrival rate for the traffic type associated with the downlink data transmission; and
skipping monitoring of the one or more first transmission opportunities based at least in part on the estimated arrival rate for the traffic type.

11. The method of claim 10, further comprising:
identifying a setting for the UE associated with a requested or target power savings;
determining a power saving level at the UE based at least in part on the setting for the UE; and
skipping monitoring of the one or more first transmission opportunities based at least in part on the determined power saving level.

12. The method of claim 1, further comprising:
skipping monitoring of the one or more first transmission opportunities of the plurality of transmission opportunities based at least in part on a current battery power level of the UE.

13. The method of claim 1, further comprising:
identifying a channel condition of a channel for the downlink data transmission; and
skipping monitoring of the channel during the one or more first transmission opportunities of the plurality of transmission opportunities based at least in part on the channel condition.

14. The method of claim 1, further comprising:
reporting a modulation and coding scheme to the base station based at least in part on the skipping, wherein the modulation and coding scheme corresponds to a number of transmission opportunities skipped by the UE.

15. The method of claim 1, further comprising:
identifying a set of higher layer retransmission parameters and a set of lower layer retransmission parameters associated with the base station; and
skipping monitoring of the one or more first transmission opportunities of the plurality of transmission opportunities based at least in part on the set of higher layer retransmission parameters and the set of lower layer retransmission parameters.

16. The method of claim 15, wherein the set of higher layer retransmission parameters comprises radio link control (RLC) parameters and the set of lower layer retransmission parameters comprises physical layer parameters.

17. The method of claim 15, wherein the set of higher layer retransmission parameters and the set of lower layer retransmission parameters comprise one or more poll timers, one or more poll prohibit timers, or any combination thereof.

18. The method of claim 1, further comprising:
skipping monitoring of the one or more first transmission opportunities of the plurality of transmission opportunities based at least in part on a set of processes to be performed by the UE, wherein the set of processes comprises at least one of a tracking loop update, a mobility update, a beam management procedure, an uplink reporting procedure, or reception of one or more reference signals, or any combination thereof.

19. The method of claim 1, wherein receiving the signaling to identify the scheduling information comprises:
receiving a downlink control channel that comprises a downlink grant indicating the scheduling information for the downlink data transmission for the UE.

20. An apparatus for wireless communication, comprising:
a processor; and
memory coupled to the processor, the processor and memory configured to:
receive signaling to identify, by a user equipment (UE), scheduling information for a downlink data transmission from a base station to the UE;
determine a plurality of transmission opportunities associated with the downlink data transmission within an on duration based at least in part on the scheduling information and one or more retransmission parameters configured for the UE;
skip monitoring of one or more first transmission opportunities of the plurality of transmission opportunities by maintaining a sleep state during the on duration based at least in part on the scheduling information and the one or more retransmission parameters configured for the UE; and
monitor, by the UE in an awake state during the on duration, for a retransmission of the downlink data transmission during one or more second transmission opportunities after the one or more first transmission opportunities of the plurality of transmission opportunities.

21. The apparatus of claim 20, wherein the processor and memory are further configured to:
identify the one or more retransmission parameters configured for the UE, wherein the one or more retransmission parameters comprises timing information for an initial downlink data retransmission, a retransmission timer associated with downlink retransmissions, a minimum hybrid automatic repeat request (HARQ) response time, or a maximum buffer time.

22. The apparatus of claim 21, wherein determining the plurality of transmission opportunities comprises the processor and memory configured to:
identify an initial transmission opportunity for the downlink data transmission, wherein the initial transmission opportunity is indicated by the scheduling information; and
determine one or more transmission opportunities associated with retransmission of the downlink data transmission based at least in part on the one or more retransmission parameters and timing information of the on duration.

23. The apparatus of claim 22, wherein the timing information of the on duration comprises a start time of the on duration, an end time of the on duration, or both.

24. The apparatus of claim 21, wherein the timing information for the initial downlink data retransmission corresponds to a number of symbols between a start of the on duration and a timing of a downlink grant for the initial downlink data retransmission.

25. The apparatus of claim 21, wherein the retransmission timer associated with downlink retransmissions corresponds to a number of slots allocated for downlink retransmissions of the downlink data transmission.

26. The apparatus of claim 20, wherein the processor and memory are further configured to:
skip monitoring of multiple transmission opportunities of the plurality of transmission opportunities based at least in part on the one or more retransmission parameters, wherein at least one of the one or more second transmission opportunities is subsequent to each of the multiple transmission opportunities.

27. The apparatus of claim 26, wherein:
the one or more first transmission opportunities comprise an initial transmission opportunity within the on duration and indicated by the scheduling information; and
the one or more second transmission opportunities comprise a last transmission opportunity within the on duration.

28. The apparatus of claim 20, wherein the processor and memory are further configured to:
skip monitoring of the one or more first transmission opportunities of the plurality of transmission opportunities based at least in part on a traffic type or a quality of service associated with the downlink data transmission.

29. The apparatus of claim 28, wherein the processor and memory are further configured to:
identify a flag indicator corresponding to the downlink data transmission, wherein the flag indicator indicates an estimated arrival rate for the traffic type associated with the downlink data transmission; and
skip monitoring of the one or more first transmission opportunities based at least in part on the estimated arrival rate for the traffic type.

30. An apparatus for wireless communication at a user equipment (UE), comprising:
means for receiving signaling to identify, by the UE, scheduling information for a downlink data transmission from a base station to the UE;
means for determining a plurality of transmission opportunities associated with the downlink data transmission within an on duration based at least in part on the scheduling information and one or more retransmission parameters configured for the UE;
means for skipping monitoring of one or more first transmission opportunities of the plurality of transmission opportunities by maintaining a sleep state during the on duration based at least in part on the scheduling information and the one or more retransmission parameters configured for the UE; and
means for monitoring, by the UE in an awake state during the on duration, for a retransmission of the downlink data transmission during one or more second transmission opportunities after the one or more first transmission opportunities of the plurality of transmission opportunities.
